(19) United States
(12) Patent Application Publication
(10) Pub. No.: US 2026/0200294 A1
(43) Pub. Date: Jul. 16, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Seong-Bin Jeong, Hwaseong-si (KR); Dongseok Oh, Hwaseong-si (KR); Eon Soo Yun, Hwaseong-si (KR); Minseob Shin, Hwaseong-si (KR); Yong Woong Cha, Hwaseong-si (KR); Jungha Park, Hwaseong-si (KR)

(73) Assignees: HYUNDAI MOTOR COMPANY, Seoul (KR); KIA CORPORATION, Seoul (KR)

(21) Appl. No.: 19/259,188

(22) Filed: Jul. 3, 2025

(30) Foreign Application Priority Data
Jan. 10, 2025 (KR) 10-2025-0004302

(51) Int. Cl. B60H 1/32; B60H 1/00; B60H 1/14; B60L 58/26; B60L 58/27; B60L 58/30; H01M 10/613; H01M 10/625; H01M 10/6569; H01M 10/663

(52) U.S. Cl. CPC B60H 1/32284; B60H 1/00278; B60H 1/143; B60L 58/26; B60L 58/27; H01M 10/613; H01M 10/625; H01M 10/6569; H01M 10/663; B60H 2001/00307; B60L 58/30; H01M 2220/20

(57) ABSTRACT

A heat pump system for a vehicle is capable of reducing the manufacturing cost and weight while streamlining the entire system by employing a single valve configured to heat the vehicle interior by using a high-temperature coolant and controlling the flowing movement of the coolant. The heat pump system is further capable of improving fast-acting properties of heating the vehicle interior by independently flowing the coolant in order to heat the vehicle interior.

### CROSS-REFERENCE TO RELATED APPLICATION

This application claims priority to and the benefit of Korean Patent Application No. 10-2025-0004302, filed with the Korean Intellectual Property Office on Jan. 10, 2025, the entire contents of which is incorporated herein by reference.

### BACKGROUND

### Technical Field

The present disclosure relates to a heat pump system for a vehicle, and more particularly, the present disclosure relates to a heat pump system for a vehicle employing a single valve configured to heat the vehicle interior.

### Description of the Related Art

An air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In the electric vehicle or the hybrid vehicle among these environment-friendly vehicles, a separate heater is not used unlike an air conditioner of a general vehicle, and an air conditioner used in the environment-friendly vehicle is generally called a heat pump system.

An electric vehicle driven by the power source of the fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system, respectively, should be configured as separate closed circuits so as to prevent heat generation of the motor, an electric component, and the battery including a fuel cell.

Therefore, there is a disadvantage in that the size and weight of the cooling module disposed at the front of the vehicle increase, and the layout of the connecting pipes supplying refrigerant or coolant to the heat pump system, cooling system, and battery cooling system inside the engine room becomes complicated.

In addition, since a battery cooling system is separately provided to warm up or cool down the battery depending on the condition of the vehicle so that the battery can provide an optimal performance, and a number of valves are applied to connect to each connecting pipe, noise and vibration caused by frequent opening and closing of these valves are transmitted to the vehicle interior, which disadvantageously reduces ride comfort.

In addition, since a separate heat-exchanger should be employed in order to recollect the waste heat from various heat sources in the heating mode of the vehicle, there is also the disadvantage of increasing the manufacturing cost.

The above information disclosed in this Background section is only to enhance understanding of the background of the disclosure. Therefore, the Background section may contain information that does not form the prior art that is already known to one having ordinary skill in the art.

### SUMMARY

The present disclosure provides a heat pump system for a vehicle capable of reducing the manufacturing cost and weight while streamlining the entire system by employing a single valve configured to heat the vehicle interior by using a high-temperature coolant and control the flowing movement of the coolant.

In addition, the present disclosure provides a heat pump system for a vehicle capable of improving fast-acting properties of heating the vehicle interior by forming independent flowing of the coolant in order to heat the vehicle interior.

In an embodiment of the present disclosure, a heat pump system for a vehicle includes a control valve configured to control the flowing movement of a coolant, including a plurality of ports. The heat pump system further includes a plurality of coolant lines connected to the control valve, and configured to selectively allow the coolant to flow by the control valve. The heat pump system further includes a radiator, an electrical component, a battery, and a heater core each connected to one coolant line among the plurality of coolant lines. The heat pump system further includes a coolant heater configured to heat the coolant flowing through two coolant lines among the plurality of coolant lines.

The heat pump system may further include an air conditioner unit including a compressor, a condenser, a first expansion valve, and an evaporator connected through a refrigerant line through which a refrigerant flows, where the air conditioner unit may further include a refrigerant connection line connected to the refrigerant line and through which the refrigerant flows, a chiller, and a second expansion valve connected to the refrigerant connection line, and where the condenser and the chiller are each provided on one coolant line among the plurality of coolant lines, to allow the coolant to selectively flow.

The plurality of coolant lines may include a first coolant line having a first end connected to the control valve to allow the coolant to selectively flow, a second coolant line having a first end connected to the control valve to allow the coolant to selectively flow, a third coolant line having a first end connected to the control valve to allow the coolant to selectively flow, and a second end connected to the electrical component, a fourth coolant line having a first end connected to the control valve to allow the coolant to selectively flow, and on which the chiller is provided, a fifth coolant line having a first end connected to the control valve to allow the coolant to selectively flow, and a second end connected to the electrical component, and a sixth coolant line having a first end connected to the control valve to allow the coolant to selectively flow, and on which the battery is provided.

The plurality of coolant lines may further include a seventh coolant line having a first end connected to the control valve to allow the coolant to selectively flow, and on which the radiator is provided, an eighth coolant line having a first end connected to the control valve to allow the coolant to selectively flow, a ninth coolant line having a first end connected to the control valve to allow the coolant to selectively flow, and on which the heater core is provided, a tenth coolant line having a first end connected to the control valve to allow the coolant to selectively flow, and on which the condenser is provided, and an eleventh coolant line having a first end connected to a second end of the first coolant line and a second end of the seventh coolant line, and having a second end connected to a second end of the ninth coolant line and a second end of the tenth coolant line.

The second end of the first coolant line may be connected to the second end of the seventh coolant line, and a second end of the second coolant line may be connected to the fourth coolant line between the chiller and a second end of the fourth coolant line.

A second end of the fourth coolant line and a second end of the eighth coolant line may be connected to a second end of the sixth coolant line, and the second end of the seventh coolant line may be connected to the second end of the first coolant line.

The coolant heater may include a first heater provided on the sixth coolant line, a second heater provided on the ninth coolant line, and a controller configured to control operations of the first heater and the second heater.

The control valve may be configured to control the flowing movement of the coolant according to at least one mode for adjusting a temperature of a vehicle interior or for adjusting a temperature of the battery, where the at least one mode may include a first mode for cooling the electrical component and the battery by using the coolant cooled in the radiator while cooling the vehicle interior. The at least one mode may further include a second mode for cooling the electrical component by using the coolant cooled in the radiator, and for cooling the battery by using the coolant heat-exchanged with the refrigerant, while cooling the vehicle interior. The at least one mode may further include a third mode for cooling the electrical component and the battery by using the coolant cooled in the radiator while heating the vehicle interior. The at least one mode may further include a fourth mode for cooling the electrical component by using the coolant cooled in the radiator, and for cooling the battery by using the coolant heat-exchanged with the refrigerant, while heating the vehicle interior. The at least one mode may further include a fifth mode for heating the battery by using the waste heat of the electrical component, while heating the vehicle interior. The at least one mode may further include a sixth mode for recollecting the waste heat of the electrical component, and heat the battery while heating the vehicle interior. The at least one mode may further include a seventh mode for recollecting an ambient air heat and the waste heat of the electrical component, and heat the battery while heating the vehicle interior.

In the first mode, the first coolant line, the third coolant line, the fourth coolant line, the fifth coolant line, the sixth coolant line, the seventh coolant line, and the tenth coolant line are opened by the control valve. The second coolant line, the eighth coolant line, and the ninth coolant line are closed by the control valve. The eleventh coolant line is opened. The third coolant line inside the control valve is connected to the first coolant line by the control valve. The fourth coolant line inside the control valve is connected to the fifth coolant line by the control valve. The seventh coolant line inside the control valve is connected to the sixth coolant line and the tenth coolant line by the control valve. The refrigerant line connecting the compressor, the condenser, the first expansion valve, and the evaporator in the air conditioner unit is opened by the first expansion valve. The refrigerant connection line is closed by the second expansion valve, and the first expansion valve expands the refrigerant introduced through the refrigerant line and supplies the expanded refrigerant to the evaporator.

In the second mode, the first coolant line, the third coolant line, the fourth coolant line, the fifth coolant line, the sixth coolant line, the seventh coolant line, and the tenth coolant line are opened by the control valve. The second coolant line, the eighth coolant line, and the ninth coolant line are closed by the control valve. The eleventh coolant line is opened. The third coolant line inside the control valve is connected to the first coolant line by the control valve. The fourth coolant line inside the control valve is connected to the sixth coolant line by the control valve. The seventh coolant line inside the control valve is connected to the fifth coolant line and the tenth coolant line by the control valve. The refrigerant line connecting the compressor, the condenser, the first expansion valve, and the evaporator in the air conditioner unit is opened by the first expansion valve. The refrigerant connection line is opened by the second expansion valve. The first expansion valve expands the refrigerant introduced through the refrigerant line and supplies the expanded refrigerant to the evaporator, and the second expansion valve expands the refrigerant introduced through the refrigerant connection line and supplies the expanded refrigerant to the chiller.

In the third mode, the first coolant line, the third coolant line, the fourth coolant line, the fifth coolant line, the sixth coolant line, the seventh coolant line, the ninth coolant line, and the tenth coolant line are opened by the control valve. The second coolant line and the eighth coolant line are closed by the control valve. The eleventh coolant line is closed. The third coolant line inside the control valve is connected to the first coolant line by the control valve. The fourth coolant line inside the control valve is connected to the fifth coolant line by the control valve. The seventh coolant line inside the control valve is connected to the sixth coolant line by the control valve. The ninth coolant line inside the control valve is connected to the tenth coolant line by the control valve. A portion of the refrigerant line connecting the compressor, the condenser, and the refrigerant connection line in the air conditioner unit is opened. A remaining portion of the refrigerant line connecting the refrigerant connection line, the first expansion valve, and the evaporator is closed by the first expansion valve. The refrigerant connection line is opened by the second expansion valve. An operation of the first expansion valve is stopped, and the second expansion valve expands the refrigerant introduced through the refrigerant connection line and supplies the expanded refrigerant to the chiller.

In the fourth mode, the first coolant line, the third coolant line, the fourth coolant line, the fifth coolant line, the sixth coolant line, the seventh coolant line, the ninth coolant line, and the tenth coolant line are opened by the control valve. The second coolant line and the eighth coolant line are closed by the control valve. The eleventh coolant line is closed. The third coolant line inside the control valve is connected to the first coolant line by the control valve. The fourth coolant line inside the control valve is connected to the sixth coolant line by the control valve. The seventh coolant line inside the control valve is connected to the fifth coolant line by the control valve. The ninth coolant line inside the control valve is connected to the tenth coolant line by the control valve. A portion of the refrigerant line connecting the compressor, the condenser, and the refrigerant connection line in the air conditioner unit is opened. A remaining portion of the refrigerant line connecting from the refrigerant connection line to the first expansion valve and the evaporator is closed by the first expansion valve. The refrigerant connection line is opened by the second expansion valve. An operation of the first expansion valve is stopped, and the second expansion valve expands the refrigerant introduced through the refrigerant connection line and supplies the expanded refrigerant to the chiller.

In the fifth mode, the first coolant line, the second coolant line, the seventh coolant line, and the eighth coolant line are closed by the control valve. The third coolant line, the fourth coolant line, the fifth coolant line, the sixth coolant line, the ninth coolant line, and the tenth coolant line are opened by the control valve. The eleventh coolant line is closed. The third coolant line inside the control valve is connected to the sixth coolant line by the control valve. The fourth coolant line inside the control valve is connected to the fifth coolant line by the control valve. The ninth coolant line inside the control valve is connected to the tenth coolant line by the control valve. A portion of the refrigerant line connecting the compressor, the condenser, and the refrigerant connection line in the air conditioner unit is opened. A remaining portion of the refrigerant line connecting from the refrigerant connection line to the first expansion valve and the evaporator is closed by the first expansion valve. The refrigerant connection line is opened by the second expansion valve. An operation of the first expansion valve is stopped, and the second expansion valve expands the refrigerant introduced through the refrigerant connection line and supplies the expanded refrigerant to the chiller.

In the sixth mode, the first coolant line and the seventh coolant line are closed by the control valve, the second coolant line, the third coolant line, the fourth coolant line, the fifth coolant line, the sixth coolant line, the eighth coolant line, the ninth coolant line, and the tenth coolant line are opened by the control valve. The eleventh coolant line is closed. The third coolant line inside the control valve is connected to the second coolant line by the control valve. The fourth coolant line inside the control valve is connected to the fifth coolant line by the control valve. The eighth coolant line inside the control valve is connected to the sixth coolant line by the control valve. The ninth coolant line inside the control valve is connected to the tenth coolant line by the control valve. A portion of the refrigerant line connecting the compressor, the condenser, and the refrigerant connection line in the air conditioner unit is opened. A remaining portion of the refrigerant line connecting from the refrigerant connection line to the first expansion valve and the evaporator is closed by the first expansion valve. The refrigerant connection line is opened by the second expansion valve. An operation of the first expansion valve is stopped, and the second expansion valve expands the refrigerant introduced through the refrigerant connection line and supplies the expanded refrigerant to the chiller.

In the seventh mode, the first coolant line, the second coolant line, the third coolant line, the fourth coolant line, and the fifth coolant line are opened by the control valve. The sixth coolant line, the seventh coolant line, the eighth coolant line, the ninth coolant line, and the tenth coolant line are opened by the control valve. The eleventh coolant line is closed. The second coolant line inside the control valve is connected to the first coolant line by the control valve. The third coolant line inside the control valve is connected to the fourth coolant line by the control valve. The seventh coolant line inside the control valve is connected to the fifth coolant line by the control valve. The eighth coolant line inside the control valve is connected to the sixth coolant line by the control valve. The ninth coolant line inside the control valve is connected to the tenth coolant line by the control valve. A portion of the refrigerant line connecting the compressor, the condenser, and the refrigerant connection line in the air conditioner unit is opened. A remaining portion of the refrigerant line connecting from the refrigerant connection line to the first expansion valve and the evaporator is closed by the first expansion valve. The refrigerant connection line is opened by the second expansion valve. An operation of the first expansion valve is stopped, and the second expansion valve expands the refrigerant introduced through the refrigerant connection line and supplies the expanded refrigerant to the chiller.

The control valve may include a first port connected to the first end of the first coolant line, a second port connected to the first end of the second coolant line, a third port connected to the first end of the third coolant line, and a fourth port connected to the first end of the fourth coolant line.

The control valve may include a fifth port connected to the first end of the fifth coolant line, a sixth port connected to the first end of the sixth coolant line, a seventh port connected to the first end of the seventh coolant line, an eighth port connected to the first end of the eighth coolant line, a ninth port connected to the first end of the ninth coolant line, and a tenth port connected to the first end of the tenth coolant line.

The heat pump system may further include at least one water pump configured to force the coolant to flow through at least one coolant line among the first to tenth coolant lines, where the at least one water pump may include a first water pump provided on a fifth port, a second water pump provided on a sixth port, and a third water pump provided on a tenth port.

A reservoir tank may be further provided on the seventh coolant line.

The air conditioner unit may further include a HVAC module including the heater core and the evaporator, and may include an opening/closing door configured to adjust air having passed through the evaporator to be selectively introduced into the heater core based on cooling or heating of a vehicle interior.

As described above, according to a heat pump system for a vehicle according to an embodiment of the present disclosure, by employing a single valve configured to heat the vehicle interior by using a high-temperature coolant and control the flowing movement of the coolant, streamlining of the entire system may be achieved.

In addition, the present disclosure can improve fast-acting properties of heating the vehicle interior may be improved by forming independent flowing of the coolant in order to heat the vehicle interior.

In addition, according to the present disclosure, by selectively using the ambient air heat, the waste heat of the electrical component, and the thermal energy generated from the refrigerant, the temperature of the battery can be efficiently controlled while adjusting the temperature of the vehicle interior, and the usage of the electric heater may be minimized at the time of heating the vehicle interior, so that power consumption may be reduced, and the overall marketability may be improved.

In addition, according to the present disclosure, the temperature of the battery is efficiently adjusted to obtain the optimal performance of the battery, thereby increasing the overall travel distance of the vehicle.

In addition, according to the present disclosure, due to streamlining of the entire system, it is possible to reduce the overall manufacturing cost and weight, and improve space utilization by minimizing the number of components.

### BRIEF DESCRIPTION OF THE DRAWINGS

FIG. 1 is a block diagram of a heat pump system for a vehicle according to an embodiment of the present disclosure.

FIG. 2 is an operation diagram according to a first mode of a heat pump system for a vehicle according to an embodiment of the present disclosure.

FIG. 3 is an operation diagram according to a second mode of a heat pump system for a vehicle according to an embodiment of the present disclosure.

FIG. 4 is an operation diagram according to a third mode of a heat pump system for a vehicle according to an embodiment of the present disclosure.

FIG. 5 is an operation diagram according to a fourth mode of a heat pump system for a vehicle according to an embodiment of the present disclosure.

FIG. 6 is an operation diagram according to a fifth mode of a heat pump system for a vehicle according to an embodiment of the present disclosure.

FIG. 7 is an operation diagram according to a sixth mode of a heat pump system for a vehicle according to an embodiment of the present disclosure.

FIG. 8 is an operation diagram according to a seventh mode of a heat pump system for a vehicle according to an embodiment of the present disclosure.

### DETAILED DESCRIPTION

Embodiments of the present disclosure are hereinafter described in detail with reference to the accompanying drawings.

Embodiments of the present disclosure in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise”, “have”, “include” and variations thereof such as “comprises” or “comprising”, should be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

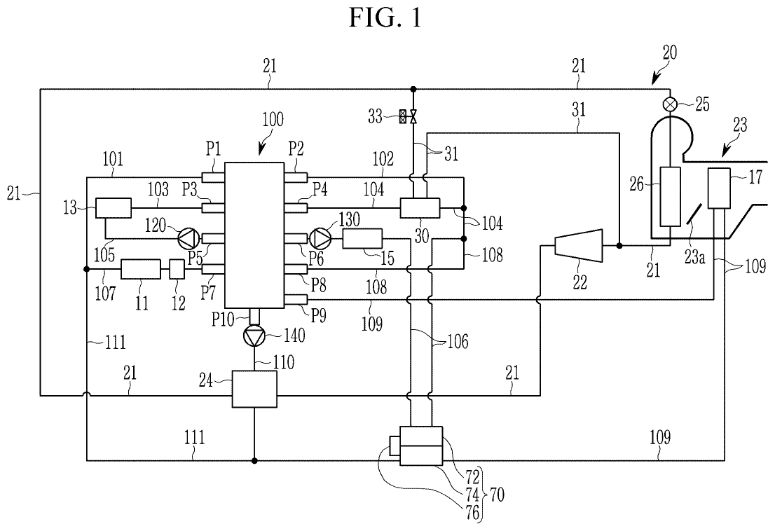

FIG. 1 is a block diagram of a heat pump system for a vehicle according to an embodiment of the present disclosure.

A heat pump system for a vehicle according to an embodiment of the present disclosure can reduce the manufacturing cost and weight while streamlining the entire system by employing a single control valve 100 configured to heat a vehicle interior by using a high-temperature coolant, and control the flowing movement of the coolant.

In addition, the present disclosure can improve fast-acting properties of heating the vehicle interior by forming the independent flow of the coolant in order to heat for the vehicle interior.

Referring to FIG. 1, in a heat pump system according to an embodiment of the present disclosure, a radiator 11, an electrical component 13, a battery 15, and a heater core 17, through which the coolant flows may be linked with an air conditioner unit 20 through which a refrigerant circulates through a condenser 24 and a chiller 30.

The air conditioner unit 20 may include a refrigerant line 21 through which the refrigerant flows, and a compressor 22, a HVAC module 23, the condenser 24, a first expansion valve 25, and an evaporator 26 interconnected through the refrigerant line 21.

The compressor 22 may compress the introduced refrigerant and allow the compressed refrigerant to flow to the refrigerant line 21 so that the refrigerant flows along the refrigerant line 21.

The evaporator 26 connected to the compressor 22 through the refrigerant line 21, and the heater core 17 to which the high-temperature coolant is selectively supplied, may be provided inside the HVAC module 23.

An opening/closing door 23a configured to adjust ambient air having passed through the evaporator 26 to be selectively introduced into the heater core 17 may be provided inside the HVAC module 23 between the evaporator 26 and the heater core 17.

The opening/closing door 23a may be opened at the time of heating the vehicle interior, so that the ambient air having passed through the evaporator 26 is introduced into the heater core 17.

In other words, the high-temperature coolant supplied to the heater core 17 may increase the temperature of the ambient air passing through the heater core 17. In other words, the introduced ambient air may be converted to a high-temperature state while passing through the heater core 17 and then introduced into the vehicle interior, thereby implementing heating of the vehicle interior.

At a time of cooling the vehicle interior, the opening/closing door 23a may close toward the heater core 17 so that the ambient air cooled while passing through the evaporator 26 is directly introduced into the vehicle.

Accordingly, the ambient air passing through the evaporator 26 may be cooled while passing through the evaporator 26 by a low-temperature refrigerant supplied to the evaporator 26. The cooled ambient air may be introduced into the vehicle interior, thereby cooling the vehicle interior.

Although not shown in the drawings, the HVAC module 23 may further include an air heater. The air heater may be disposed toward the vehicle interior, at a downstream side of the heater core 17 inside the HVAC module 23 to selectively heat the ambient air having passed through the heater core 17.

In an embodiment of the present disclosure, the condenser 24 may be connected to the compressor 22 through the refrigerant line 21. The condenser 24 may condense the refrigerant supplied from the compressor 22 by using the selectively introduced coolant.

The first expansion valve 25 may be provided on the refrigerant line 21 connecting the condenser 24 and the evaporator 26. The first expansion valve 25 may selectively expand the introduced refrigerant.

The first expansion valve 25 may be a mechanical expansion valve configured to expand the refrigerant introduced through the refrigerant line 21.

An embodiment of the present disclosure takes an example in which the first expansion valve 25 is a mechanical expansion valve, but is not limited thereto, and the first expansion valve 25 may be an electronic expansion valve configured to selectively expand the refrigerant while controlling the flow of the supplied refrigerant.

In addition, the evaporator 26 may be provided on the refrigerant line 21 between the first expansion valve 25 and the compressor 22.

The evaporator 26 may evaporate the expanded refrigerant supplied from the first expansion valve 25 through heat-exchange with the air passing through the HVAC module 23.

The air conditioner unit 20 may further include the chiller 30, a refrigerant connection line 31, and a second expansion valve 33.

The chiller 30 may be provided on the refrigerant connection line 31. The coolant may selectively circulate through the chiller 30.

The chiller 30 configured as such may adjust the temperature of the coolant by exchanging heat between the refrigerant introduced into the refrigerant connection line 31 and the selectively introduced coolant.

The chiller 30 may adjust the temperature of the coolant by exchanging heat between the supplied refrigerant and the coolant. The chiller 30 may be a water-cooled heat-exchanger configured to exchange heat between the interiorly introduced refrigerant and the coolant.

A first end of the refrigerant connection line 31 may be connected to the refrigerant line 21 between the condenser 24 and the first expansion valve 25. A second end of the refrigerant connection line 31 may be connected to the refrigerant line 21 between the evaporator 26 and the compressor 22.

In other words, the chiller 30 may adjust the temperature of the coolant by exchanging heat between the coolant and the refrigerant that are selectively introduced.

In addition, the second expansion valve 33 may be disposed at an upstream end of the chiller 30 based on the flow direction of the refrigerant flowing along the refrigerant connection line 31 so that the refrigerant is introduced thereinto before being supplied to the chiller 30.

The second expansion valve 33 may be an electronic expansion valve configured to selectively expand the refrigerant while controlling the flow of the supplied refrigerant.

In other words, the upstream end of the chiller 30 may be set based on the flow direction of the refrigerant. Based on a direction in which the refrigerant flows along the refrigerant connection line 31, the location where the refrigerant is introduced into the chiller 30 may be defined as the upstream end of the chiller 30, and the location where the refrigerant is discharged from the chiller 30 may be defined as the downstream end of the chiller 30.

In addition, a heat pump system according to an embodiment of the present disclosure may further include the control valve 100 and a plurality of coolant lines.

The control valve 100 may control the flowing movement of the coolant depending on at least one mode for the temperature adjustment of the vehicle interior or the temperature adjustment of the battery 15, and may be formed with a plurality of ports.

A detailed configuration of the plurality of ports is described in detail hereinbelow.

The plurality of coolant lines may be connected to the control valve 100 and may selectively allow the coolant to flow by the control valve 100.

In an embodiment of the present disclosure, the radiator 11, the electrical component 13, the battery 15, and the heater core 17 may be connected to or provided on one coolant line among the plurality of coolant lines.

In addition, the condenser 24 and the chiller 30 may be provided on one coolant line among the plurality of coolant lines, to allow the coolant to selectively flow.

The plurality of lines may include a first coolant line 101, a second coolant line 102, a third coolant line 103, a fourth coolant line 104, a fifth coolant line 105, a sixth coolant line 106, a seventh coolant line 107, an eighth coolant line 108, a ninth coolant line 109, a tenth coolant line 110, and an eleventh coolant line 111.

A first end of the first coolant line 101 may be connected to the control valve 100, to selectively allow the coolant to flow.

A first end of the second coolant line 102 may be connected to the control valve 100, to selectively allow the coolant to flow.

A first end of the third coolant line 103 may be connected to the control valve 100, to selectively allow the coolant to flow. A second end of the third coolant line 103 may be connected to the electrical component 13.

The electrical component 13 may include an electric power control unit (EPCU), or an inverter, or an on-board charger (OBC), or an autonomous driving controller, or the like.

The electrical component 13 configured as such may be connected to third coolant line 103 and cooled by a water-cooled manner.

A first end of the fourth coolant line 104 may be connected to the control valve 100, to selectively allow the coolant to flow. The chiller 30 may be provided on the fourth coolant line 104.

The chiller 30 may heat-exchange the coolant flowing through the fourth coolant line 104 with the refrigerant supplied from the second expansion valve 33 through the refrigerant connection line 31.

The chiller 30 configured as such may be a water-cooled heat-exchanger into which the coolant is introduced through the fourth coolant line 104.

In an embodiment of the present disclosure, a first end of the fifth coolant line 105 may be connected to the control valve 100, to selectively allow the coolant to flow. A second end of the fifth coolant line 105 may be connected to the electrical component 13.

A first end of the sixth coolant line 106 may be connected to the control valve 100, to selectively allow the coolant to flow. The battery 15 may be provided on the sixth coolant line 106.

Accordingly, the battery 15 may be provided on the sixth coolant line 106 and cooled by a water-cooled manner.

In an embodiment of the present disclosure, a first end of the seventh coolant line 107 may be connected to the control valve 100, to selectively allow the coolant to flow. The radiator 11 may be provided on the seventh coolant line 107.

The radiator 11 may be disposed at the front of the vehicle. A cooling fan (not shown) may be provided on a downstream side of the radiator 11. Accordingly, the radiator 11 may cool the coolant through an operation of the cooling fan and heat-exchange with the ambient air.

A reservoir tank 12 may be further provided on the seventh coolant line 107. The coolant cooled in the radiator 11 may be stored in the reservoir tank 12.

A first end of the eighth coolant line 108 may be connected to the control valve 100, to selectively allow the coolant to flow.

A first end of the ninth coolant line 109 may be connected to the control valve 100, to selectively allow the coolant to flow. The heater core 17 may be provided on the ninth coolant line 109.

Accordingly, when the vehicle interior is to be heated, the high-temperature coolant may be introduced into the heater core 17 through the ninth coolant line 109.

In an embodiment of the present disclosure, a first end of the tenth coolant line 110 may be connected to the control valve 100, to selectively allow the coolant to flow. The condenser 24 may be provided on the tenth coolant line 110.

Accordingly, the condenser 24 may condense the refrigerant, and increase the temperature of the coolant, while exchanging heat between the refrigerant supplied to the refrigerant line 21 from the compressor 22 and the coolant supplied through the tenth coolant line 110.

In addition, a first end of the eleventh coolant line 111 may be connected to a second end of the first coolant line 101 and a second end of the seventh coolant line 107. A second end of the eleventh coolant line 111 may be connected to a second end of the ninth coolant line 109 and a second end of the tenth coolant line 110.

The second end of the first coolant line 101 may be connected to the second end of the seventh coolant line 107.

A second end of the second coolant line 102 may be connected to the fourth coolant line 104 between the chiller 30 and a second end of the fourth coolant line 104.

The second end of the fourth coolant line 104 and a second end of the eighth coolant line 108 may be respectively connected to a second end of the sixth coolant line 106.

In addition, the second end of the seventh coolant line 107 may be connected to the second end of the first coolant line 101.

The control valve 100 may include a first port P1, a second port P2, a third port P3, a fourth port P4, a fifth port P5, a sixth port P6, a seventh port P7, an eighth port P8, a ninth port P9, and a tenth port P10.

The first port P1 may be connected to the first end of the first coolant line 101. The second port P2 may be connected to the first end of the second coolant line 102. The third port P3 may be connected to the first end of the third coolant line 103.

The fourth port P4 may be connected to the first end of the fourth coolant line 104. The fifth port P5 may be connected to the first end of the fifth coolant line 105. The sixth port P6 may be connected to the first end of the sixth coolant line 106.

The seventh port P7 may be connected to the first end of the seventh coolant line 107. The eighth port P8 may be connected to the first end of the eighth coolant line 108. The ninth port P9 may be connected to the first end of the ninth coolant line 109.

In addition, the first end of the tenth coolant line 110 may be connected to the tenth port P10.

At least one water pump may be provided in the control valve 100, so that the coolant flows through at least one line among the first to tenth coolant lines 101-110.

In an embodiment of the present disclosure, the at least one water pump may include a first water pump 120 provided on the fifth port P5, a second water pump 130 provided on the sixth port P6, and a third water pump 140 provided on the tenth port P10.

The first, second, and the third water pumps 120, 130, and 140 may be electric water pumps.

The heat pump system may further include a coolant heater 70 configured to independently heat the coolant respectively flowing through selected two coolant lines among the plurality of coolant lines.

The coolant heater 70 may be provided on the sixth coolant line 106 and the ninth coolant line 109.

The coolant heater 70 may include a first heater 72, a second heater 74, and a controller 76.

The first heater 72 may be provided on the sixth coolant line 106. The first heater 72 may selectively heat the coolant so that the temperature of the coolant introduced through the sixth coolant line 106 is increased.

The second heater 74 may be provided on the ninth coolant line 109. The second heater 74 may selectively heat the coolant so that the temperature of the coolant introduced through the ninth coolant line 109 is increased.

The first heater 72 and the second heater 74 may be integrally formed. In addition, the coolants passing through the first heater 72 and the second heater 74, respectively, are not mixed with each other, so that mutual heat transfer therebetween is prevented.

In addition, the controller 76 may be provided on the first heater 72 and a first side of the second heater 74. The controller 76 may control operations of the first heater 72 and the second heater 74.

According to the heat pump system configured as such, the flowing movement of the coolant may be controlled by the control valve 100 depending on the at least one mode for the temperature adjustment of the vehicle interior or the temperature adjustment of the battery 15.

The at least one mode may include a first mode, a second mode, a third mode, a fourth mode, a fifth mode, a sixth mode, and a seventh mode.

In the first mode, the electrical component 13 and the battery 15 may be cooled by using the coolant cooled in the radiator 11, while cooling the vehicle interior.

The second mode may, while cooling the vehicle interior, cool the electrical component 13 by using the coolant cooled in the radiator 11, and cool the battery 15 by using the coolant heat-exchanged with the refrigerant.

The third mode may cool the electrical component 13 and the battery 15 by using the coolant cooled in the radiator 11, while heating the vehicle interior.

In the fourth mode, the electrical component 13 may be cooled by using the coolant cooled in the radiator 11, while heating the vehicle interior, and may cool the battery 15 by using the coolant heat-exchanged with the refrigerant.

In the fifth mode, the battery 15 may be heated by using a waste heat of the electrical component 13, while heating the vehicle interior.

In the sixth mode, while heating the vehicle interior, the waste heat of the electrical component 13 may be recollected and the battery 15 may be heated.

In addition, in the seventh mode, while heating the vehicle interior, ambient air heat and the waste heat of the electrical component 13 may be recollected, and the battery 15 may be heated.

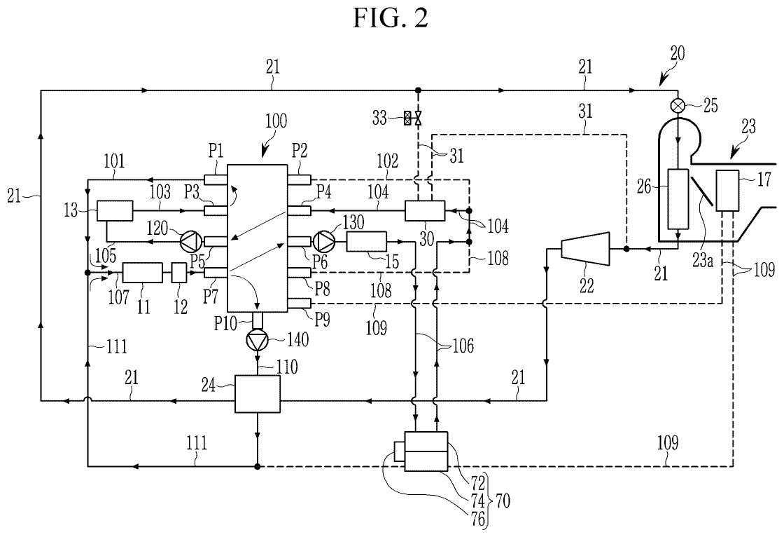

An operation and action of a heat pump system according to an embodiment of the present disclosure configured as such are described in detail below with reference to FIGS. 2-8.

An operation in the first mode for cooling the electrical component 13 and the battery 15 by using the coolant cooled in the radiator 11 while cooling the vehicle interior is described in detail below with reference to FIG. 2.

FIG. 2 is an operation diagram according to a first mode of a heat pump system for a vehicle according to an embodiment of the present disclosure.

Referring to FIG. 2, in the first mode, the heat pump system may cool the electrical component 13 and the battery 15 by using the coolant cooled in the radiator 11 while cooling the vehicle interior.

In order to cool the vehicle interior, the compressor 22 may be operated, so that the refrigerant flows along the refrigerant line 21.

The refrigerant line 21 may be opened by the first expansion valve 25 so that the compressor 22, the condenser 24, the first expansion valve 25, and the evaporator 26 are interconnected.

The refrigerant connection line 31 may be closed by the second expansion valve 33.

The first coolant line 101, the third coolant line 103, the fourth coolant line 104, the fifth coolant line 105, the sixth coolant line 106, the seventh coolant line 107, and the tenth coolant line 110 may be opened by the control valve 100.

The second coolant line 102, the eighth coolant line 108, and the ninth coolant line 109 may be closed by the control valve 100.

In addition, the eleventh coolant line 111 may be opened.

Within the control valve 100, the third coolant line 103 may be connected to the first coolant line 101 by the control valve 100.

In addition, within the control valve 100, the fourth coolant line 104 may be connected to the fifth coolant line 105 by the control valve 100.

In addition, within the control valve 100, the seventh coolant line 107 may be connected to the sixth coolant line 106 and the tenth coolant line 110 by the control valve 100.

The first water pump 120, the second water pump 130, and the third water pump 140 may each be operated.

The coolant flowing from the fifth port P5 of the control valve 100 along the fifth coolant line 105 by the first water pump 120 may be introduced into the electrical component 13.

The coolant having passed through the electrical component 13 may flow through the third coolant line 103, and may be introduced into the control valve 100 through the third port P3.

The coolant introduced through the third port P3 may flow along the first coolant line 101 connected to the first port P1 by the control valve 100.

The coolant flowing from the tenth port P10 of the control valve 100 along the opened tenth coolant line 110 by the third water pump 140 may pass through the condenser 24.

The condenser 24 may condense the refrigerant while exchanging heat between the refrigerant supplied from the compressor 22 through the refrigerant line 21, and the coolant flowing through the tenth coolant line 110.

The refrigerant condensed in the condenser 24 may be introduced into the first expansion valve 25 along the refrigerant line 21.

The coolant having passed through the condenser 24 may flow along the tenth coolant line 110 and the eleventh coolant line 111.

Accordingly, the coolant flowing through the first coolant line 101 may flow to the seventh coolant line 107 together with the coolant flowing through the eleventh coolant line 111.

The coolant flowing through the seventh coolant line 107 may be cooled through heat-exchange with the ambient air while passing through the radiator 11. The coolant cooled in the radiator 11 may be introduced into the control valve 100 through the seventh port P7.

A partial coolant among the coolant introduced into the control valve 100 through the seventh port P7 may flow to the sixth port P6 by the control valve 100.

In addition, a remaining coolant among the coolant introduced into the control valve 100 through the seventh port P7 may flow to the tenth port P10 by the control valve 100.

The coolant flowing from the sixth port P6 of the control valve 100 along the sixth coolant line 106 by the second water pump 130 may pass through the battery 15.

The coolant having passed through the battery 15 may pass through the first heater 72 of the coolant heater 70 along the sixth coolant line 106. The coolant heater 70 may not be operated by the controller 76.

The coolant flowing from the coolant heater 70 along the sixth coolant line 106 may pass through the chiller 30 while flowing along the fourth coolant line 104 connected to the sixth coolant line 106.

The coolant may flow without heat-exchange while passing through the chiller 30 that is not supplied with the refrigerant.

The coolant having passed through the chiller 30 may flow through the fourth coolant line 104, and may be introduced into the control valve 100 through the fourth port P4.

The coolant introduced into the control valve 100 through the fourth port P4 may flow to the fifth port P5 by the control valve 100, and may flow to the fifth coolant line 105 connected to the fifth port P5, thereby repeatedly performing the above-described processes.

While repeatedly performing such an operation, the coolant cooled in the radiator 11 may cool the electrical component 13 and the battery 15, and may condense the refrigerant supplied to the condenser 24.

The coolant cooled in the radiator 11 may first pass through the battery 15 by the control valve 100 and then pass through the electrical component 13.

Accordingly, the coolant cooled in the radiator 11 may first cool the battery 15, and then cool the electrical component 13, thereby cooling the battery 15 rapidly and efficiently.

The refrigerant condensed in the condenser 24 may be introduced into the first expansion valve 25 along the refrigerant line 21. The first expansion valve 25 may expand the refrigerant introduced through the refrigerant line 21, and may supply the expanded refrigerant to the evaporator 26 through the refrigerant line 21.

Accordingly, the low-temperature refrigerant may be supplied to the evaporator 26. In such a state, the ambient air introduced into the HVAC module 23 may be cooled while passing through the evaporator 26 by the low-temperature refrigerant introduced into the evaporator 26.

The opening/closing door 23a may close a portion toward the heater core 17 so that the cooled ambient air does not pass through the heater core 17. Therefore, the cooled ambient air may be directly introduced into the vehicle interior, thereby smoothly cooling the vehicle interior.

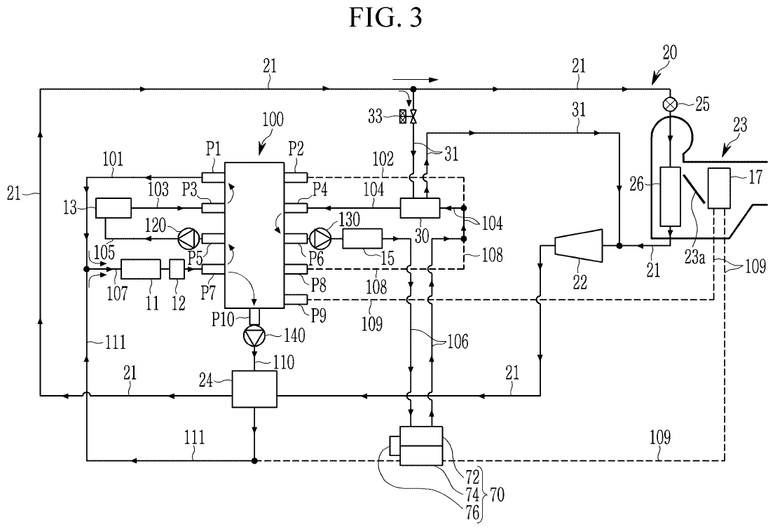

In an embodiment of the present disclosure, an operation of the second mode for cooling the electrical component 13 by using the coolant cooled in the radiator 11, and for cooling the battery 15 by using the coolant heat-exchanged with the refrigerant, while cooling the vehicle interior is described in detail below with reference to FIG. 3.

FIG. 3 is an operation diagram according to a second mode of a heat pump system for a vehicle according to an embodiment of the present disclosure.

Referring to FIG. 3, in the second mode, the heat pump system may, while cooling the vehicle interior, cool the electrical component 13 by using the coolant cooled in the radiator 11, and cool the battery 15 by using the coolant heat-exchanged with the refrigerant.

In order to cool the vehicle interior, the compressor 22 may be operated, so that the refrigerant flows along the refrigerant line 21.

The refrigerant line 21 may be opened by the first expansion valve 25 so that the compressor 22, the condenser 24, the first expansion valve 25, and the evaporator 26 are interconnected.

The refrigerant connection line 31 may be opened by the second expansion valve 33.

The first coolant line 101, the third coolant line 103, the fourth coolant line 104, the fifth coolant line 105, the sixth coolant line 106, the seventh coolant line 107, and the tenth coolant line 110 may be opened by the control valve 100.

The second coolant line 102, the eighth coolant line 108, and the ninth coolant line 109 may be closed by the control valve 100.

In addition, the eleventh coolant line 111 may be opened.

Within the control valve 100, the third coolant line 103 may be connected to the first coolant line 101 by the control valve 100.

In addition, within the control valve 100, the fourth coolant line 104 may be connected to the sixth coolant line 106 by the control valve 100.

In addition, within the control valve 100, the seventh coolant line 107 may be connected to the fifth coolant line 105 and the tenth coolant line 110 by the control valve 100.

In such a state, the first water pump 120, the second water pump 130, and the third water pump 140 may be each operated.

The coolant flowing from the fifth port P5 of the control valve 100 along the fifth coolant line 105 by the first water pump 120 may be introduced into the electrical component 13.

The coolant having passed through the electrical component 13 may flow through the third coolant line 103, and may be introduced into the control valve 100 through the third port P3.

The coolant introduced through the third port P3 may flow along the first coolant line 101 connected to the first port P1 by the control valve 100.

The coolant flowing from the tenth port P10 of the control valve 100 along the opened tenth coolant line 110 by the third water pump 140 may pass through the condenser 24.

The condenser 24 may condense the refrigerant while exchanging heat between the refrigerant supplied from the compressor 22 through the refrigerant line 21, and the coolant flowing through the tenth coolant line 110.

The refrigerant condensed in the condenser 24 may be introduced into the first expansion valve 25 along the refrigerant line 21.

The coolant having passed through the condenser 24 may flow along the tenth coolant line 110 and the eleventh coolant line 111.

Accordingly, the coolant flowing through the first coolant line 101 may flow to the seventh coolant line 107 together with the coolant flowing through the eleventh coolant line 111.

The coolant flowing through the seventh coolant line 107 may be cooled through heat-exchange with the ambient air while passing through the radiator 11. Thereafter, the coolant cooled in the radiator 11 may be introduced into the control valve 100 through the seventh port P7.

A partial coolant among the coolant introduced into the control valve 100 through the seventh port P7 may flow to the fifth port P5 by the control valve 100.

In addition, a remaining coolant among the coolant introduced into the control valve 100 through the seventh port P7 may flow to the tenth port P10 by the control valve 100.

While repeatedly performing such an operation, the coolant cooled in the radiator 11 may cool the electrical component 13, and may condense the refrigerant supplied to the condenser 24.

The coolant flowing from the sixth port P6 of the control valve 100 along the sixth coolant line 106 by the second water pump 130 may pass through the battery 15.

The coolant having passed through the battery 15 may pass through the first heater 72 of the coolant heater 70 along the sixth coolant line 106. The coolant heater 70 may not be operated by the controller 76.

The coolant flowing from the coolant heater 70 along the sixth coolant line 106 may pass through the chiller 30 while flowing along the fourth coolant line 104 connected to the sixth coolant line 106.

A partial refrigerant among the refrigerant condensed in the condenser 24 may be introduced into the chiller 30 through the opened refrigerant connection line 31. The second expansion valve 33 may expand the refrigerant introduced through the refrigerant connection line 31 and supply the expanded refrigerant to the chiller 30.

The low-temperature refrigerant may be introduced into the chiller 30 through the refrigerant connection line 31.

The low-temperature refrigerant introduced into the chiller 30 may cool the coolant flowing along the fourth coolant line 104 while exchanging heat with the coolant introduced from the battery 15 through the sixth coolant line 106 and the fourth coolant line 104.

The coolant cooled in the chiller 30 may flow along the fourth coolant line 104, and may be introduced into the control valve 100 through the fourth port P4.

The coolant introduced into the control valve 100 through the fourth port P4 may flow to the sixth port P6 by the control valve 100, thereby repeatedly performing the above-described processes.

In other words, the coolant cooled in the chiller 30 may be supplied to the battery 15 along the sixth coolant line 106 connected to the sixth port P6 by the control valve 100. Accordingly, the battery 15 may be efficiently cooled by the coolant cooled in the chiller 30 through heat-exchange with the refrigerant.

A remaining refrigerant among the refrigerant condensed in the condenser 24 may be introduced into the first expansion valve 25 along the refrigerant line 21. The first expansion valve 25 may expand the refrigerant introduced through the refrigerant line 21, and may supply the expanded refrigerant to the evaporator 26 through the refrigerant line 21.

Accordingly, the low-temperature refrigerant may be supplied to the evaporator 26. In such a state, the ambient air introduced into the HVAC module 23 may be cooled while passing through the evaporator 26 by the low-temperature refrigerant introduced into the evaporator 26.

The opening/closing door 23a may close a portion toward the heater core 17 so that the cooled ambient air does not pass through the heater core 17. Therefore, the cooled ambient air may be directly introduced into the vehicle interior, thereby smoothly cooling the vehicle interior.

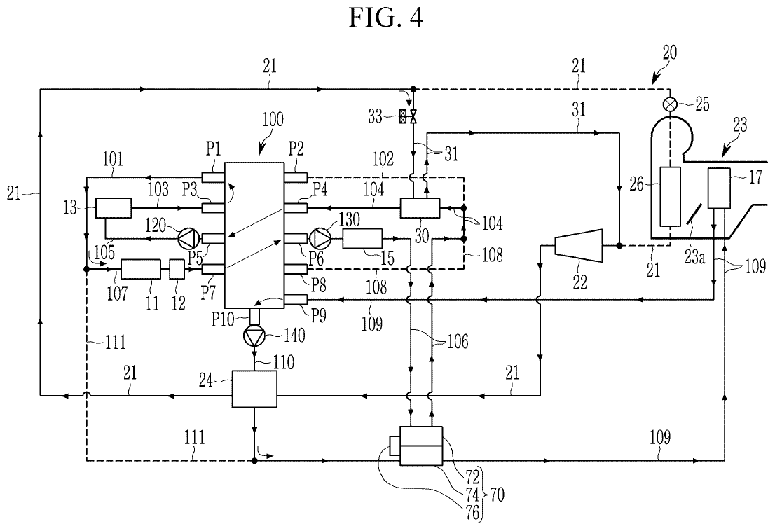

In an embodiment of the present disclosure, an operation in the third mode for cooling the electrical component 13 and the battery 15 by using the coolant cooled in the radiator 11 while heating the vehicle interior is described in detail below with reference to FIG. 4.

FIG. 4 is an operation diagram according to a third mode of a heat pump system for a vehicle according to an embodiment of the present disclosure.

Referring to FIG. 4, in the third mode, the heat pump system may cool the electrical component 13 and the battery 15 by using the coolant cooled in the radiator 11, while heating the vehicle interior.

In order to heat the vehicle interior, the compressor 22 may be operated, so that the refrigerant flows along the refrigerant line 21.

In the air conditioner unit 20, a portion of the refrigerant line 21 connecting the compressor 22, the condenser 24, and the first end of the refrigerant connection line 31 may be opened.

A remaining portion of the refrigerant line 21 connecting the first end of the refrigerant connection line 31 to the second end of the refrigerant connection line 31 via the first expansion valve 25 and the evaporator 26 may be closed by the first expansion valve 25.

An operation of the first expansion valve 25 may be stopped.

In addition, the refrigerant connection line 31 may be opened by the second expansion valve 33.

The first coolant line 101, the third coolant line 103, the fourth coolant line 104, the fifth coolant line 105, the sixth coolant line 106, the seventh coolant line 107, the ninth coolant line 109, and the tenth coolant line 110 may be opened by the control valve 100.

The second coolant line 102 and the eighth coolant line 108 may be closed by the control valve 100.

In addition, the eleventh coolant line 111 may be closed.

Within the control valve 100, the third coolant line 103 may be connected to the first coolant line 101 by the control valve 100.

In addition, within the control valve 100, the fourth coolant line 104 may be connected to the fifth coolant line 105 by the control valve 100.

In addition, within the control valve 100, the seventh coolant line 107 may be connected to the sixth coolant line 106 by the control valve 100.

In addition, within the control valve 100, the ninth coolant line 109 may be connected to the tenth coolant line 110 by the control valve 100.

In such a state, the first water pump 120, the second water pump 130, and the third water pump 140 may each be operated.

The coolant flowing from the fifth port P5 of the control valve 100 along the fifth coolant line 105 by the first water pump 120 may be introduced into the electrical component 13.

The coolant having passed through the electrical component 13 may flow through the third coolant line 103, and may be introduced into the control valve 100 through the third port P3.

The coolant introduced through the third port P3 may flow along the first coolant line 101 connected to the first port P1 by the control valve 100. In addition, the coolant flowing through the first coolant line 101 may flow to the seventh coolant line 107.

The coolant flowing through the seventh coolant line 107 may be cooled through heat-exchange with the ambient air while passing through the radiator 11. The coolant cooled in the radiator 11 may be introduced into the control valve 100 through the seventh port P7.

The coolant introduced into the control valve 100 through the seventh port P7 may flow to the sixth port P6 by the control valve 100.

The coolant flowing from the seventh port P7 to the sixth port P6 by the control valve 100 may flow from the sixth port P6 of the control valve 100 along the sixth coolant line 106 by the second water pump 130.

The coolant flowing through the sixth coolant line 106 may pass through the battery 15.

The coolant having passed through the battery 15 may pass through the first heater 72 of the coolant heater 70 along the sixth coolant line 106., The coolant heater 70 may not be operated by the controller 76.

The coolant flowing from the coolant heater 70 along the sixth coolant line 106 may pass through the chiller 30 while flowing along the fourth coolant line 104 connected to the sixth coolant line 106.

The refrigerant condensed in the condenser 24 may be introduced into the chiller 30 through the opened refrigerant connection line 31. The second expansion valve 33 may expand the refrigerant introduced through the refrigerant connection line 31 and supply the expanded refrigerant to the chiller 30.

The chiller 30 may evaporate the introduced refrigerant through heat-exchange with the coolant. The refrigerant evaporated in the chiller 30 may be supplied to the compressor 22 through the refrigerant connection line 31 and a portion of the refrigerant line 21, and may repeatedly perform the above-described processes.

The coolant having passed through the chiller 30 may flow through the fourth coolant line 104, and may be introduced into the control valve 100 through the fourth port P4.

The coolant introduced into the control valve 100 through the fourth port P4 may flow to the fifth port P5 by the control valve 100, and may flow to the fifth coolant line 105 connected to the fifth port P5, thereby repeatedly performing the above-described processes.

While repeatedly performing such an operation, the coolant cooled in the radiator 11 may cool the electrical component 13 and the battery 15.

The coolant cooled in the radiator 11 may first pass through the battery 15 by the control valve 100 and then pass through the electrical component 13.

Accordingly, the coolant cooled in the radiator 11 may first cool the battery 15, and then cool the electrical component 13, thereby cooling the battery 15 rapidly and efficiently.

The coolant flowing from the tenth port P10 of the control valve 100 along the tenth coolant line 110 by the third water pump 140 may pass through the condenser 24.

The condenser 24 may condense the refrigerant while exchanging heat between the refrigerant supplied from the compressor 22 through the refrigerant line 21, and the coolant flowing through the tenth coolant line 110.

The refrigerant condensed in the condenser 24 may flow along the refrigerant line 21, and may flow along the opened refrigerant connection line 31.

The condenser 24 may increase the temperature of the coolant, while exchanging heat between the coolant introduced through the tenth coolant line 110 and the high-temperature refrigerant supplied from the compressor 22.

The coolant heated while passing through the condenser 24 may pass through the second heater 74 of the coolant heater 70 along the ninth coolant line 109 connected to the tenth coolant line 110, to be then introduced into the heater core 17.

The second heater 74 may be operated when the temperature of the coolant flowing through the ninth coolant line 109 is low.

In other words, when the temperature of the coolant flowing through the ninth coolant line 109 is lower than or equal to a predetermined temperature, the second heater 74 may be operated by the controller 76 to increase the temperature of the coolant.

Accordingly, when the second heater 74 is operated, the temperature of the coolant supplied to the heater core 17 can be rapidly increased.

The opening/closing door 23a may be opened, so that the ambient air having been introduced into the HVAC module 23 and having passed through the evaporator 26 passes through the heater core 17.

Accordingly, the ambient air introduced from the outside may be introduced at a room-temperature state without being cooled, when passing through the evaporator 26 that is not supplied with the refrigerant. The introduced ambient air may be converted to a high-temperature state while passing through the heater core 17 and then introduced into the vehicle interior, thereby implementing heating of the vehicle interior.

The coolant having passed through the heater core 17 may flow through the ninth coolant line 109, and may be introduced into the ninth port P9. The coolant introduced into the ninth port P9 may flow along the tenth coolant line 110 connected to the tenth port P10 by the control valve 100, thereby repeatedly performing the above-described processes.

In other words, in the third mode, the electrical component 13 and the battery 15 may be efficiently cooled by using the coolant cooled in the radiator 11, and the vehicle interior may be heated by using the coolant heat-exchanged with the refrigerant in the condenser 24.

In addition, in the third mode, for heating the vehicle interior, the control valve 100 may enable the coolant to independently circulates along the ninth coolant line 109 and the tenth coolant line 110, thereby improving fast-acting properties of the heating.

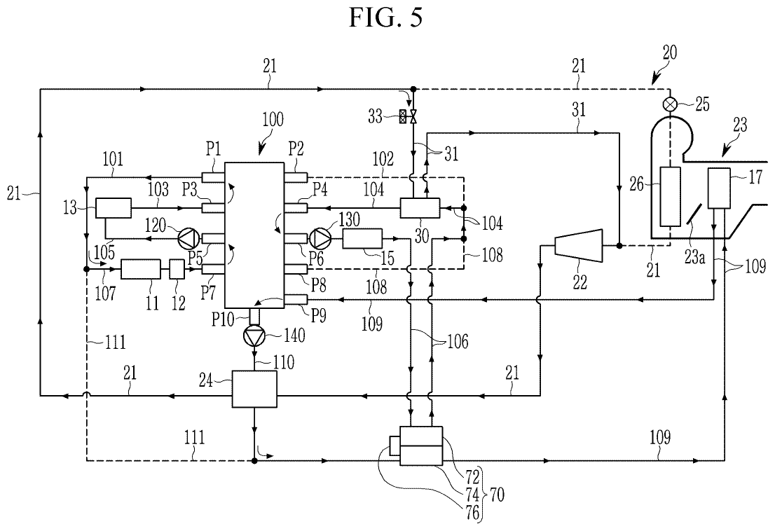

In an embodiment of the present disclosure, an operation in the fourth mode for cooling the electrical component 13 by using the coolant cooled in the radiator 11, and for cooling the battery 15 by using the coolant heat-exchanged with the refrigerant, while heating the vehicle interior is described in detail below with reference to FIG. 5.

FIG. 5 is an operation diagram according to a fourth mode of a heat pump system for a vehicle according to an embodiment of the present disclosure.

Referring to FIG. 5, in the fourth mode, in the heat pump system, the electrical component 13 may be cooled by using the coolant cooled in the radiator 11, while heating the vehicle interior, and may cool the battery 15 by using the coolant heat-exchanged with the refrigerant.

In order to heat the vehicle interior, the compressor 22 may be operated, so that the refrigerant flows along the refrigerant line 21.

In the air conditioner unit 20, a portion of the refrigerant line 21 connecting the compressor 22, the condenser 24, and the first end of the refrigerant connection line 31 may be opened.

A remaining portion of the refrigerant line 21 connecting the first end of the refrigerant connection line 31 to the second end of the refrigerant connection line 31 via the first expansion valve 25 and the evaporator 26 may be closed by the first expansion valve 25.

The operation of the first expansion valve 25 may be stopped.

In addition, the refrigerant connection line 31 may be opened by the second expansion valve 33.

The first coolant line 101, the third coolant line 103, the fourth coolant line 104, the fifth coolant line 105, the sixth coolant line 106, the seventh coolant line 107, the ninth coolant line 109, and the tenth coolant line 110 may be opened by the control valve 100.

The second coolant line 102 and the eighth coolant line 108 may be closed by the control valve 100.

In addition, the eleventh coolant line 111 may be closed.

Within the control valve 100, the third coolant line 103 may be connected to the first coolant line 101 by the control valve 100.

In addition, within the control valve 100, the fourth coolant line 104 may be connected to the sixth coolant line 106 by the control valve 100.

In addition, within the control valve 100, the seventh coolant line 107 may be connected to the fifth coolant line 105 by the control valve 100.

In addition, within the control valve 100, the ninth coolant line 109 may be connected to the tenth coolant line 110 by the control valve 100.

In such a state, the first water pump 120, the second water pump 130, and the third water pump 140 may each be operated.

The coolant flowing from the fifth port P5 of the control valve 100 along the fifth coolant line 105 by the first water pump 120 may be introduced into the electrical component 13.

The coolant having passed through the electrical component 13 may flow through the third coolant line 103, and may be introduced into the control valve 100 through the third port P3.

The coolant introduced through the third port P3 may flow along the first coolant line 101 connected to the first port P1 by the control valve 100. In addition, the coolant flowing through the first coolant line 101 may flow to the seventh coolant line 107.

The coolant flowing through the seventh coolant line 107 may be cooled through heat-exchange with the ambient air while passing through the radiator 11. The coolant cooled in the radiator 11 may be introduced into the control valve 100 through the seventh port P7.

The coolant introduced into the control valve 100 through the seventh port P7 may flow to the fifth port P5 by the control valve 100.

While repeatedly performing such an operation, the coolant cooled in the radiator 11 may cool the electrical component 13.

The coolant flowing from the sixth port P6 of the control valve 100 along the sixth coolant line 106 by the second water pump 130 may pass through the battery 15.

The coolant having passed through the battery 15 may pass through the first heater 72 of the coolant heater 70 along the sixth coolant line 106. The coolant heater 70 may not be operated by the controller 76.

The coolant flowing from the coolant heater 70 along the sixth coolant line 106 may pass through the chiller 30 while flowing along the fourth coolant line 104 connected to the sixth coolant line 106.

The refrigerant condensed in the condenser 24 may be introduced into the chiller 30 through the opened refrigerant connection line 31. The second expansion valve 33 may expand the refrigerant introduced through the refrigerant connection line 31 and supply the expanded refrigerant to the chiller 30.

The low-temperature refrigerant may be introduced into the chiller 30 through the refrigerant connection line 31.

The low-temperature refrigerant introduced into the chiller 30 may cool the coolant flowing along the fourth coolant line 104 while exchanging heat with the coolant introduced from the battery 15 through the sixth coolant line 106 and the fourth coolant line 104.

The chiller 30 may evaporate the introduced refrigerant through heat-exchange with the coolant. The refrigerant evaporated in the chiller 30 may be supplied to the compressor 22 through the refrigerant connection line 31 and a portion of the refrigerant line 21, and may repeatedly perform the above-described processes.

The coolant cooled in the chiller 30 may flow along the fourth coolant line 104, and may be introduced into the control valve 100 through the fourth port P4.

The coolant introduced into the control valve 100 through the fourth port P4 may flow to the sixth port P6 by the control valve 100, thereby repeatedly performing the above-described processes.

In other words, the coolant cooled in the chiller 30 may be supplied to the battery 15 along the sixth coolant line 106 connected to the sixth port P6 by the control valve 100. Accordingly, the battery 15 may be efficiently cooled by the coolant cooled in the chiller 30 through heat-exchange with the refrigerant.

The coolant having passed through the chiller 30 may flow through the fourth coolant line 104, and may be introduced into the control valve 100 through the fourth port P4.

The coolant introduced into the control valve 100 through the fourth port P4 may flow to the sixth port P6 by the control valve 100, and may flow to the sixth coolant line 106 connected to the sixth port P6, thereby repeatedly performing the above-described processes.

The coolant flowing from the tenth port P10 of the control valve 100 along the tenth coolant line 110 by the third water pump 140 may pass through the condenser 24.

The condenser 24 may condense the refrigerant while exchanging heat between the refrigerant supplied from the compressor 22 through the refrigerant line 21, and the coolant flowing through the tenth coolant line 110.

The refrigerant condensed in the condenser 24 may flow along the refrigerant line 21, and may flow along the opened refrigerant connection line 31.

The condenser 24 may increase the temperature of the coolant, while exchanging heat between the coolant introduced through the tenth coolant line 110 and the high-temperature refrigerant supplied from the compressor 22.

The coolant heated while passing through the condenser 24 may pass through the second heater 74 of the coolant heater 70 along the ninth coolant line 109 connected to the tenth coolant line 110, to be then introduced into the heater core 17.

The second heater 74 may be operated when the temperature of the coolant flowing through the ninth coolant line 109 is low.

In other words, when the temperature of the coolant flowing through the ninth coolant line 109 is lower than or equal to a predetermined temperature, the second heater 74 may be operated by the controller 76 to increase the temperature of the coolant.

Accordingly, when the second heater 74 is operated, the temperature of the coolant supplied to the heater core 17 can be rapidly increased.

The opening/closing door 23a may be opened, so that the ambient air having been introduced into the HVAC module 23 and having passed through the evaporator 26 passes through the heater core 17.

Accordingly, the ambient air introduced from the outside may be introduced at a room-temperature state without being cooled, when passing through the evaporator 26 that is not supplied with the refrigerant. The introduced ambient air may be converted to a high-temperature state while passing through the heater core 17 and then introduced into the vehicle interior, thereby implementing heating of the vehicle interior.

The coolant having passed through the heater core 17 may flow through the ninth coolant line 109, and may be introduced into the ninth port P9. The coolant introduced into the ninth port P9 may flow along the tenth coolant line 110 connected to the tenth port P10 by the control valve 100, thereby repeatedly performing the above-described processes.

In other words, the fourth mode may cool the electrical component 13 by using the coolant cooled in the radiator 11, and may efficiently cool the battery 15 by using the coolant cooled in the chiller 30 through heat-exchange with the refrigerant.

In the fourth mode, the vehicle interior may be heated by using the coolant heat-exchanged with the refrigerant in the condenser 24.

In addition, in the fourth mode, for heating the vehicle interior, the control valve 100 may enable the coolant to independently circulate along the ninth coolant line 109 and the tenth coolant line 110, thereby improving fast-acting properties of the heating.

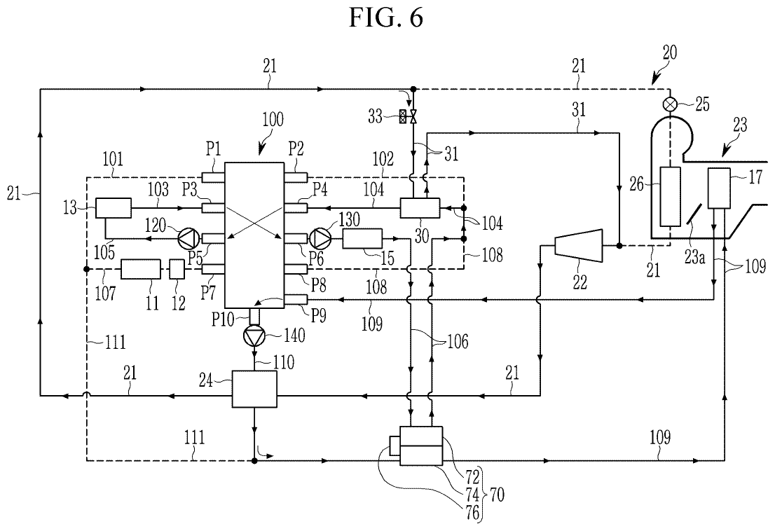

In an embodiment of the present disclosure, an operation in the fifth mode for heating the battery 15 by using the waste heat of the electrical component 13 while heating the vehicle interior is described in detail below with reference to FIG. 6.

FIG. 6 is an operation diagram according to a fifth mode of a heat pump system for a vehicle according to an embodiment of the present disclosure.

Referring to FIG. 6, in the fifth mode, the heat pump system may heat the battery 15 by using the waste heat of the electrical component 13 while heating the vehicle interior.

In order to heat the vehicle interior, the compressor 22 may be operated, so that the refrigerant flows along the refrigerant line 21.

In the air conditioner unit 20, a portion of the refrigerant line 21 connecting the compressor 22, the condenser 24, and the first end of the refrigerant connection line 31 may be opened.

A remaining portion of the refrigerant line 21 connecting from the first end of the refrigerant connection line 31 to the second end of the refrigerant connection line 31 via the first expansion valve 25 and the evaporator 26 may be closed by the first expansion valve 25.

The operation of the first expansion valve 25 may be stopped.

In addition, the refrigerant connection line 31 may be opened by the second expansion valve 33.

The first coolant line 101, the second coolant line 102, the seventh coolant line 107, and the eighth coolant line 108 may be closed by the control valve 100.

The third coolant line 103, the fourth coolant line 104, the fifth coolant line 105, the sixth coolant line 106, the ninth coolant line 109, and the tenth coolant line 110 may be opened by the control valve 100.

In addition, the eleventh coolant line 111 may be closed.

Within the control valve 100, the third coolant line 103 may be connected to the sixth coolant line 106 by the control valve 100.

In addition, within the control valve 100, the fourth coolant line 104 may be connected to the fifth coolant line 105 by the control valve 100.

In addition, within the control valve 100, the ninth coolant line 109 may be connected to the tenth coolant line 110 by the control valve 100.

In such a state, the first water pump 120, the second water pump 130, and the third water pump 140 may be each operated.

The coolant flowing from the fifth port P5 of the control valve 100 along the fifth coolant line 105 by the first water pump 120 may be introduced into the electrical component 13.

The coolant introduced into the electrical component 13 may have a temperature increased by the waste heat of the electrical component 13 while cooling the electrical component 13.

The coolant heated while passing through the electrical component 13 may flow along the third coolant line 103, and may be introduced into the control valve 100 through the third port P3. The coolant introduced through the third port P3 may flow to the sixth port P6 by the control valve 100.

The coolant flowing from the third port P3 to the sixth port P6 by the control valve 100 may flow from the sixth port P6 of the control valve 100 along the sixth coolant line 106 by the second water pump 130. The coolant flowing through the sixth coolant line 106 may pass through the battery 15.

Accordingly, the battery 15 may be efficiently heated by the high-temperature coolant supplied through the sixth coolant line 106.

The coolant having passed through the battery 15 may pass through the first heater 72 of the coolant heater 70 along the sixth coolant line 106. The coolant heater 70 may not be operated by the controller 76.

The coolant flowing from the coolant heater 70 along the sixth coolant line 106 may pass through the chiller 30 while flowing along the fourth coolant line 104 connected to the sixth coolant line 106.

The refrigerant condensed in the condenser 24 may be introduced into the chiller 30 through the opened refrigerant connection line 31. The second expansion valve 33 may expand the refrigerant introduced through the refrigerant connection line 31 and supply the expanded refrigerant to the chiller 30.

The low-temperature refrigerant may be introduced into the chiller 30 through the refrigerant connection line 31.

The low-temperature refrigerant introduced into the chiller 30 may cool the coolant flowing along the fourth coolant line 104 while exchanging heat with the coolant introduced from the battery 15 through the sixth coolant line 106 and the fourth coolant line 104.

The chiller 30 may evaporate the introduced refrigerant through heat-exchange with the coolant. The refrigerant evaporated in the chiller 30 may be supplied to the compressor 22 through the refrigerant connection line 31 and a portion of the refrigerant line 21, and may repeatedly perform the above-described processes.

The coolant cooled in the chiller 30 may flow along the fourth coolant line 104, and may be introduced into the control valve 100 through the fourth port P4.

The coolant introduced into the control valve 100 through the fourth port P4 may flow to the fifth port P5 by the control valve 100, thereby repeatedly performing the above-described processes.

In other words, the coolant cooled in the chiller 30 may be supplied to the electrical component 13 along the fifth coolant line 105 connected to the fifth port P5 by the control valve 100.

Accordingly, the electrical component 13 may be cooled by the coolant cooled in the chiller 30 through heat-exchange with the refrigerant. In addition, the battery 15 may be efficiently heated by the coolant heated while cooling the electrical component 13.

The coolant flowing from the tenth port P10 of the control valve 100 along the tenth coolant line 110 by the third water pump 140 may pass through the condenser 24.

The condenser 24 may condense the refrigerant while exchanging heat between the refrigerant supplied from the compressor 22 through the refrigerant line 21, and the coolant flowing through the tenth coolant line 110.

The refrigerant condensed in the condenser 24 may flow along the refrigerant line 21, and may flow along the opened refrigerant connection line 31.

The condenser 24 may increase the temperature of the coolant, while exchanging heat between the coolant introduced through the tenth coolant line 110 and the high-temperature refrigerant supplied from the compressor 22.

The coolant heated while passing through the condenser 24 may pass through the second heater 74 of the coolant heater 70 along the ninth coolant line 109 connected to the tenth coolant line 110, to be then introduced into the heater core 17.

The second heater 74 may be operated when the temperature of the coolant flowing through the ninth coolant line 109 is low.

In other words, when the temperature of the coolant flowing through the ninth coolant line 109 is lower than or equal to a predetermined temperature, the second heater 74 may be operated by the controller 76 to increase the temperature of the coolant.

Accordingly, when the second heater 74 is operated, the temperature of the coolant supplied to the heater core 17 can be rapidly increased.

The opening/closing door 23a may be opened, so that the ambient air having been introduced into the HVAC module 23 and having passed through the evaporator 26 passes through the heater core 17.

Accordingly, the ambient air introduced from the outside may be introduced at a room-temperature state without being cooled, when passing through the evaporator 26 that is not supplied with the refrigerant. The introduced ambient air may be converted to a high-temperature state while passing through the heater core 17 and then introduced into the vehicle interior, thereby implementing heating of the vehicle interior.

The coolant having passed through the heater core 17 may flow through the ninth coolant line 109, and may be introduced into the ninth port P9. The coolant introduced into the ninth port P9 may flow along the tenth coolant line 110 connected to the tenth port P10 by the control valve 100, thereby repeatedly performing the above-described processes.

In other words, in the fifth mode, the battery 15 may be efficiently heated by using the coolant heated while cooling the electrical component 13.

In the fifth mode, the vehicle interior may be heated by using the coolant heat-exchanged with the refrigerant in the condenser 24.

In addition, in the fifth mode, for heating the vehicle interior, the control valve 100 may enable the coolant to independently circulate along the ninth coolant line 109 and the tenth coolant line 110, thereby improving fast-acting properties of the heating.

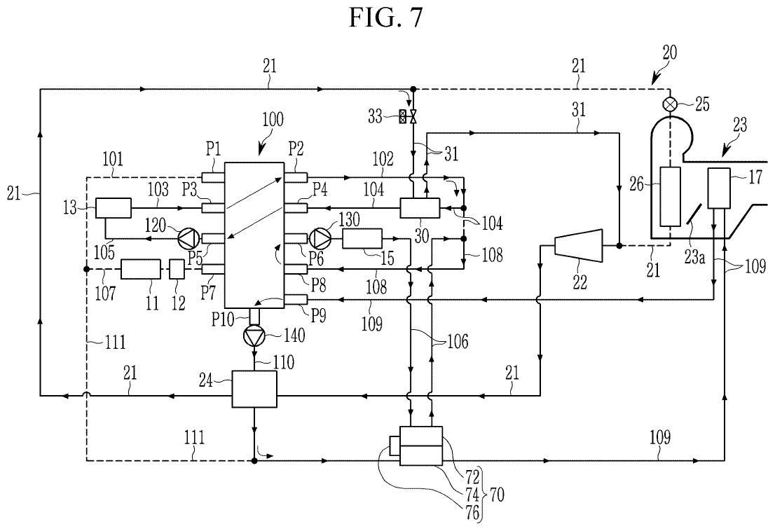

In an embodiment of the present disclosure, an operation in the sixth mode for recollecting the waste heat of the electrical component 13 while heating the vehicle interior and for heating the battery 15 is described in detail below with reference to FIG. 7.

FIG. 7 is an operation diagram according to a sixth mode of a heat pump system for a vehicle according to an embodiment of the present disclosure.

Referring to FIG. 7, in the sixth mode, in the heat pump system, while heating the vehicle interior, the waste heat of the electrical component 13 may be recollected and the battery 15 may be heated.

In order to heat the vehicle interior, the compressor 22 may be operated, so that the refrigerant flows along the refrigerant line 21.

In the air conditioner unit 20, a portion of the refrigerant line 21 connecting the compressor 22, the condenser 24, and the first end of the refrigerant connection line 31 may be opened.

A remaining portion of the refrigerant line 21 connecting from the first end of the refrigerant connection line 31 to the second end of the refrigerant connection line 31 via the first expansion valve 25 and the evaporator 26 may be closed by the first expansion valve 25.

The operation of the first expansion valve 25 may be stopped.

In addition, the refrigerant connection line 31 may be opened by the second expansion valve 33.

The first coolant line 101 and the seventh coolant line 107 may be closed by the control valve 100.

The second coolant line 102, the third coolant line 103, the fourth coolant line 104, the fifth coolant line 105, the sixth coolant line 106, the eighth coolant line 108, the ninth coolant line 109, and the tenth coolant line 110 may be opened by the control valve 100.

In addition, the eleventh coolant line 111 may be closed.

Within the control valve 100, the third coolant line 103 may be connected to the second coolant line 102 by the control valve 100.

In addition, within the control valve 100, the fourth coolant line 104 may be connected to the fifth coolant line 105 by the control valve 100.

In addition, within the control valve 100, the eighth coolant line 108 may be connected to the sixth coolant line 106 by the control valve 100.

In addition, within the control valve 100, the ninth coolant line 109 may be connected to the tenth coolant line 110 by the control valve 100.

In such a state, the first water pump 120, the second water pump 130, and the third water pump 140 may be each operated.

The coolant flowing from the fifth port P5 of the control valve 100 along the fifth coolant line 105 by the first water pump 120 may be introduced into the electrical component 13.

The coolant introduced into the electrical component 13 may have a temperature increased by the waste heat of the electrical component 13 while cooling the electrical component 13.

The coolant heated while passing through the electrical component 13 may flow along the third coolant line 103, and may be introduced into the control valve 100 through the third port P3. The coolant introduced through the third port P3 may flow to the second port P2 by the control valve 100.

The coolant flowing from the third port P3 to the second port P2 by the control valve 100 may flow from the second port P2 of the control valve 100 along the second coolant line 102. The coolant flowing through the second coolant line 102 may pass through the chiller 30 while flowing along the fourth coolant line 104 connected to the second coolant line 102.

The refrigerant condensed in the condenser 24 may be introduced into the chiller 30 through the opened refrigerant connection line 31. The second expansion valve 33 may expand the refrigerant introduced through the refrigerant connection line 31 and supply the expanded refrigerant to the chiller 30.

The low-temperature refrigerant may be introduced into the chiller 30 through the refrigerant connection line 31.

The low-temperature refrigerant introduced into the chiller 30 may cool the coolant flowing through the fourth coolant line 104 while being heat-exchanged with the coolant heated while cooling the electrical component 13.

The chiller 30 may recollect the waste heat of the electrical component 13, while evaporating the introduced refrigerant through heat-exchange with the high-temperature coolant.

The coolant heated by absorbing the waste heat of the electrical component 13 may be recollected while increasing the temperature of the refrigerant supplied to the chiller 30, while passing through the chiller 30.

In other words, the chiller 30 may heat the refrigerant by exchanging heat between the coolant and the refrigerant in order to recollect the waste heat from the coolant heated while passing through the electrical component 13. The heated refrigerant may be supplied to the compressor 22 through the refrigerant connection line 31 and a portion of the refrigerant line 21, and may repeatedly perform the above-described processes.

The coolant cooled in the chiller 30 may flow along the fourth coolant line 104, and may be introduced into the control valve 100 through the fourth port P4.

The coolant introduced into the control valve 100 through the fourth port P4 may flow to the fifth port P5 by the control valve 100, thereby repeatedly performing the above-described processes.

The coolant flowing from the sixth port P6 of the control valve 100 along the sixth coolant line 106 by the second water pump 130 may pass through the battery 15.

The coolant having passed through the battery 15 may pass through the first heater 72 of the coolant heater 70 along the sixth coolant line 106. The coolant heater 70 may be operated by the controller 76.

Accordingly, the first heater 72 may heat the introduced coolant to have an increased temperature. The coolant heated in the first heater 72 may flow along the eighth coolant line 108 connected to the sixth coolant line 106.

The coolant flowing through the eighth coolant line 108 may be introduced into the control valve 100 through the eighth port P8. The coolant introduced into the control valve 100 through the eighth port P8 may flow to the sixth port P6 by the control valve 100, thereby repeatedly performing the above-described processes.

In other words, the battery 15 may be efficiently heated by the coolant heated in the coolant heater 70 while circulating along the sixth coolant line 106 and the eighth coolant line 108.

The coolant flowing from the tenth port P10 of the control valve 100 along the tenth coolant line 110 by the third water pump 140 may pass through the condenser 24.

The condenser 24 may condense the refrigerant while exchanging heat between the refrigerant supplied from the compressor 22 through the refrigerant line 21, and the coolant flowing through the tenth coolant line 110.

The refrigerant condensed in the condenser 24 may flow along the refrigerant line 21, and may flow along the opened refrigerant connection line 31.

The condenser 24 may increase the temperature of the coolant, while exchanging heat between the coolant introduced through the tenth coolant line 110 and the high-temperature refrigerant supplied from the compressor 22.

The coolant heated while passing through the condenser 24 may pass through the second heater 74 of the coolant heater 70 along the ninth coolant line 109 connected to the tenth coolant line 110, to be then introduced into the heater core 17.

The second heater 74 may be operated when the temperature of the coolant flowing through the ninth coolant line 109 is low.

In other words, when the temperature of the coolant flowing through the ninth coolant line 109 is lower than or equal to a predetermined temperature, the second heater 74 may be operated by the controller 76 to increase the temperature of the coolant.

Accordingly, when the second heater 74 is operated, the temperature of the coolant supplied to the heater core 17 can be rapidly increased.

The opening/closing door 23a may be opened, so that the ambient air having been introduced into the HVAC module 23 and having passed through the evaporator 26 passes through the heater core 17.

Accordingly, the ambient air introduced from the outside may be introduced at a room-temperature state without being cooled, when passing through the evaporator 26 that is not supplied with the refrigerant. The introduced ambient air may be converted to a high-temperature state while passing through the heater core 17 and then introduced into the vehicle interior, thereby implementing heating of the vehicle interior.

The coolant having passed through the heater core 17 may flow through the ninth coolant line 109, and may be introduced into the ninth port P9. The coolant introduced into the ninth port P9 may flow along the tenth coolant line 110 connected to the tenth port P10 by the control valve 100, thereby repeatedly performing the above-described processes.

In other words, in the sixth mode, the waste heat of the electrical component 13 may be absorbed by the chiller 30 and used to increase the temperature of the refrigerant, thereby reducing the power consumption of the compressor 22.

In addition, in the sixth mode, for heating the battery 15, the control valve 100 may independently circulate the coolant through the sixth coolant line 106 and the eighth coolant line 108, and increase the temperature of the coolant by using the coolant heater 70, thereby rapidly increasing the temperature of the battery 15.

In the sixth mode, the vehicle interior may be heated by using the coolant heat-exchanged with the refrigerant in the condenser 24.

In addition, in the sixth mode, for heating the vehicle interior, the control valve 100 may enable the coolant to independently circulates along the ninth coolant line 109 and the tenth coolant line 110, thereby improving fast-acting properties of the heating.

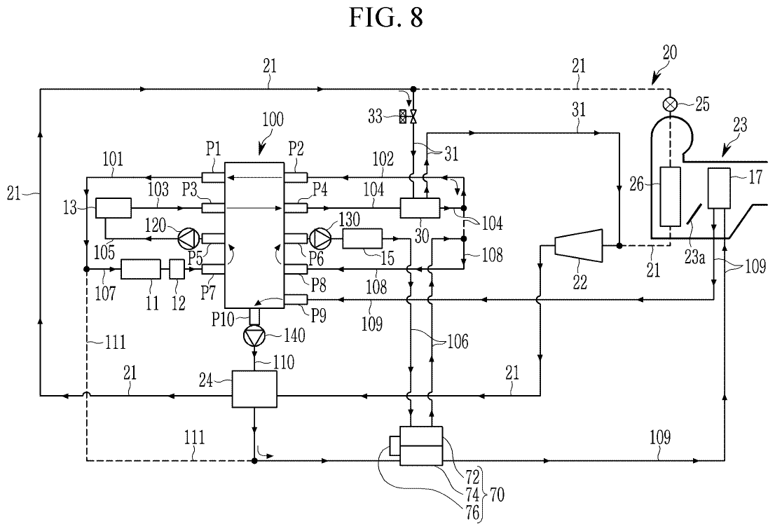

In addition, an operation in the seventh mode for recollecting the ambient air heat and the waste heat of the electrical component 13 while heating the vehicle interior, and for heating the battery 15 is described in detail below with reference to FIG. 8.

FIG. 8 is an operation diagram according to a seventh mode of a heat pump system for a vehicle according to an embodiment of the present disclosure.

Referring to FIG. 8, in the seventh mode, the heat pump system may, while heating the vehicle interior, recollect the ambient air heat and the waste heat of the electrical component 13, and heat the battery 15.

In order to heat the vehicle interior, the compressor 22 may be operated, so that the refrigerant flows along the refrigerant line 21.

In the air conditioner unit 20, a portion of the refrigerant line 21 connecting the compressor 22, the condenser 24, and the first end of the refrigerant connection line 31 may be opened.

A remaining portion of the refrigerant line 21 connecting from the first end of the refrigerant connection line 31 to the second end of the refrigerant connection line 31 via the first expansion valve 25 and the evaporator 26 may be closed by the first expansion valve 25.

The operation of the first expansion valve 25 may be stopped.

In addition, the refrigerant connection line 31 may be opened by the second expansion valve 33.

The first coolant line 101, the second coolant line 102, the third coolant line 103, the fourth coolant line 104, and the fifth coolant line 105 may be opened by the control valve 100.

The sixth coolant line 106, the seventh coolant line 107, the eighth coolant line 108, the ninth coolant line 109, and the tenth coolant line 110 may be opened by the control valve 100.

In addition, the eleventh coolant line 111 may be closed.

Within the control valve 100, the second coolant line 102 may be connected to the first coolant line 101 by the control valve 100.

In addition, within the control valve 100, the third coolant line 103 may be connected to the fourth coolant line 104 by the control valve 100.

In addition, within the control valve 100, the seventh coolant line 107 may be connected to the fifth coolant line 105 by the control valve 100.

In addition, within the control valve 100, the eighth coolant line 108 may be connected to the sixth coolant line 106 by the control valve 100.

In addition, within the control valve 100, the ninth coolant line 109 may be connected to the tenth coolant line 110 by the control valve 100.

In such a state, the first water pump 120, the second water pump 130, and the third water pump 140 may each be operated.

The coolant flowing from the fifth port P5 of the control valve 100 along the fifth coolant line 105 by the first water pump 120 may be introduced into the electrical component 13.

The coolant introduced into the electrical component 13 may have a temperature increased by the waste heat of the electrical component 13 while cooling the electrical component 13.

The coolant heated while passing through the electrical component 13 may flow along the third coolant line 103, and may be introduced into the control valve 100 through the third port P3. The coolant introduced through the third port P3 may flow to the fourth port P4 by the control valve 100.

The coolant flowing from the third port P3 to the fourth port P4 by the control valve 100 may flow from the fourth port P4 of the control valve 100 along the fourth coolant line 104.

The coolant flowing through the fourth coolant line 104 may pass through the chiller 30 and then flow along the second coolant line 102 connected to the fourth coolant line 104, and may be introduced into the control valve 100 through the second port P2.

The coolant introduced into the second port P2 may flow along the first coolant line 101 connected to the first port P1 by the control valve 100. In addition, the coolant flowing through the first coolant line 101 may flow to the seventh coolant line 107.

The coolant flowing through the seventh coolant line 107 may be heat-exchanged with the ambient air while passing through the radiator 11. The coolant may absorb the ambient air heat. The coolant having passed through the radiator 11 may be introduced into the control valve 100 through the seventh port P7.

The coolant introduced into the control valve 100 through the seventh port P7 may flow to the fifth port P5 by the control valve 100, thereby repeatedly performing the above-described operations.

The refrigerant condensed in the condenser 24 may be introduced into the chiller 30 through the opened refrigerant connection line 31. The second expansion valve 33 may expand the refrigerant introduced through the refrigerant connection line 31 and supply the expanded refrigerant to the chiller 30.

The low-temperature refrigerant may be introduced into the chiller 30 through the refrigerant connection line 31.

The low-temperature refrigerant introduced into the chiller 30 may absorb the ambient air heat at the radiator 11, and may cool the coolant flowing through the fourth coolant line 104 while being heat-exchanged with the coolant heated while cooling the electrical component 13.

The chiller 30 may recollect the ambient air heat and the waste heat of the electrical component 13 while evaporating the introduced refrigerant through heat-exchange with the high-temperature coolant.

The ambient air heat and the coolant heated by absorbing the waste heat of the electrical component 13 may be recollected while increasing the temperature of the refrigerant supplied to the chiller 30, while passing through the chiller 30.

In other words, the chiller 30 may heat the refrigerant by exchanging heat between the coolant and the refrigerant in order to recollect the waste heat from the coolant heated while passing through the electrical component 13. The heated refrigerant may be supplied to the compressor 22 through the refrigerant connection line 31 and a portion of the refrigerant line 21, and may repeatedly perform the above-described processes.

The coolant flowing from the sixth port P6 of the control valve 100 along the sixth coolant line 106 by the second water pump 130 may pass through the battery 15.

The coolant having passed through the battery 15 may pass through the first heater 72 of the coolant heater 70 along the sixth coolant line 106. The coolant heater 70 may be operated by the controller 76.

Accordingly, the first heater 72 may heat the introduced coolant to have an increased temperature. The coolant heated in the first heater 72 may flow along the eighth coolant line 108 connected to the sixth coolant line 106.

The coolant flowing through the eighth coolant line 108 may be introduced into the control valve 100 through the eighth port P8. The coolant introduced into the control valve 100 through the eighth port P8 may flow to the sixth port P6 by the control valve 100, thereby repeatedly performing the above-described processes.

In other words, the battery 15 may be efficiently heated by the coolant heated in the coolant heater 70 while circulating along the sixth coolant line 106 and the eighth coolant line 108.

The coolant flowing from the tenth port P10 of the control valve 100 along the tenth coolant line 110 by the third water pump 140 may pass through the condenser 24.

The condenser 24 may condense the refrigerant while exchanging heat between the refrigerant supplied from the compressor 22 through the refrigerant line 21, and the coolant flowing through the tenth coolant line 110.

The refrigerant condensed in the condenser 24 may flow along the refrigerant line 21, and may flow along the opened refrigerant connection line 31.

The condenser 24 may increase the temperature of the coolant, while exchanging heat between the coolant introduced through the tenth coolant line 110 and the high-temperature refrigerant supplied from the compressor 22.

The coolant heated while passing through the condenser 24 may pass through the second heater 74 of the coolant heater 70 along the ninth coolant line 109 connected to the tenth coolant line 110, to be then introduced into the heater core 17.

The second heater 74 may be operated when the temperature of the coolant flowing through the ninth coolant line 109 is low.

In other words, when the temperature of the coolant flowing through the ninth coolant line 109 is lower than or equal to a predetermined temperature, the second heater 74 may be operated by the controller 76 to increase the temperature of the coolant.

Accordingly, when the second heater 74 is operated, the temperature of the coolant supplied to the heater core 17 can be rapidly increased.

The opening/closing door 23a may be opened, so that the ambient air having been introduced into the HVAC module 23 and having passed through the evaporator 26 passes through the heater core 17.

Accordingly, the ambient air introduced from the outside may be introduced at a room-temperature state without being cooled, when passing through the evaporator 26 that is not supplied with the refrigerant. The introduced ambient air may be converted to a high-temperature state while passing through the heater core 17 and then introduced into the vehicle interior, thereby implementing heating of the vehicle interior.

The coolant having passed through the heater core 17 may flow through the ninth coolant line 109, and may be introduced into the ninth port P9. The coolant introduced into the ninth port P9 may flow along the tenth coolant line 110 connected to the tenth port P10 by the control valve 100, thereby repeatedly performing the above-described processes.

In other words, in the seventh mode, the ambient air heat and the waste heat of the electrical component 13 may be absorbed by the chiller 30 and used to increase the temperature of the refrigerant, thereby reducing the power consumption of the compressor 22.

In addition, in the seventh mode, for heating the battery 15, the control valve 100 may independently circulate the coolant through the sixth coolant line 106 and the eighth coolant line 108, and increase the temperature of the coolant by using the coolant heater 70, thereby rapidly increasing the temperature of the battery 15.

In the seventh mode, the vehicle interior may be heated by using the coolant heat-exchanged with the refrigerant in the condenser 24.

In addition, in the seventh mode, for heating the vehicle interior, the control valve 100 may enable the coolant to independently circulate along the ninth coolant line 109 and the tenth coolant line 110, thereby improving fast-acting properties of the heating.

As described above, according to a heat pump system for a vehicle according to an embodiment of the present disclosure, by employing the single control valve 100 configured to heat the vehicle interior by using the high-temperature coolant, and control the flowing movement of the coolant, streamlining of the entire system can be achieved.

In addition, according to the present disclosure, by forming the independent flowing movement of the coolant in order to heat the vehicle interior, the fast-acting properties of heating the vehicle interior can be improved.

In addition, according to the present disclosure, by selectively using the ambient air heat, the waste heat of the electrical component 13, and the thermal energy generated in the refrigerant, the temperature of the battery 15 can be efficiently controlled while adjusting the temperature of the vehicle interior, and the usage of the electric heater may be minimized at the time of heating the vehicle interior, so that power consumption may be reduced, and the overall marketability may be improved.

In addition, according to the present disclosure, the temperature of the battery 15 is efficiently adjusted so as to obtain the optimal performance of the battery 15, thereby increasing the overall travel distance of the vehicle.

In addition, according to the present disclosure, due to streamlining of the entire system, it is possible to reduce the overall manufacturing cost and weight, and improve space utilization by minimizing the number of components.

While this disclosure has been described in connection with what is presently considered to be practical embodiments of the present disclosure, it is to be understood that the disclosure is not limited to the disclosed embodiments. On the contrary, it is intended to cover various modifications and equivalent arrangements included within the spirit and scope of the appended claims.

### Description of Symbols

11: radiator
12: reservoir tank
13: electrical component
15: battery
17: heater core
20: air conditioner unit
21: refrigerant line
22: compressor
24: condenser
25: first expansion valve
26: evaporator
30: chiller
31: refrigerant connection line
33: second expansion valve
70: coolant heater
72, 74: first and second heaters
76: controller
100: control valve
101, 102: first and second coolant lines
103, 104: third and fourth coolant lines
105, 106: fifth and sixth coolant lines
107, 108: seventh and eighth coolant lines
109, 110: ninth and tenth coolant lines
111: eleventh coolant line
120: first water pump
130: second water pump
140: third water pump
P1, P2: first and second ports
P3, P4: third and fourth ports
P5, P6: fifth and sixth ports
P7, P8: seventh and eighth ports
P9, P10: ninth and tenth ports

What is claimed is:

1. A heat pump system for a vehicle, the heat pump system comprising:
a control valve including a plurality of ports, the control valve being configured to control a flowing movement of a coolant;
a plurality of coolant lines connected to the control valve, and configured to selectively allow the coolant to flow by the control valve;
a radiator, an electrical component, a battery, and a heater core, each connected to a respective coolant line among the plurality of coolant lines, and
a coolant heater configured to heat the coolant flowing through two coolant lines among the plurality of coolant lines.

2. The heat pump system of claim 1, further comprising an air conditioner unit comprising a compressor, a condenser, a first expansion valve, and an evaporator connected through a refrigerant line through which a refrigerant flows,
wherein the air conditioner unit further comprises a refrigerant connection line connected to the refrigerant line and through which the refrigerant flows, a chiller, and a second expansion valve connected to the refrigerant connection line, and
wherein the condenser and the chiller are each connected to one coolant line among the plurality of coolant lines, to allow the coolant to flow.

3. The heat pump system of claim 2, wherein the plurality of coolant lines comprises:
a first coolant line configured to allow the coolant to flow and including a first end connected to the control valve;
a second coolant line configured to allow the coolant to flow and including a first end connected to the control valve;
a third coolant line configured to allow the coolant to flow and including a first end connected to the control valve, and a second end connected to the electrical component;
a fourth coolant line configured to allow the coolant to flow and including a first end connected to the control valve, wherein the chiller is connected to the fourth coolant line;
a fifth coolant line configured to allow the coolant to flow and including a first end connected to the control valve, and a second end connected to the electrical component; and
a sixth coolant line configured to allow the coolant to flow and including a first end connected to the control valve, wherein the battery is connected to the sixth coolant line.

4. The heat pump system of claim 3, wherein the plurality of coolant lines further comprises:
a seventh coolant line configured to allow the coolant to flow and including a first end connected to the control valve, wherein the radiator is connected to the seventh coolant line;
an eighth coolant line configured to allow the coolant to flow and including a first end connected to the control valve;
a ninth coolant line configured to allow the coolant to flow and including a first end connected to the control valve, wherein the heater core is connected to the ninth coolant line;
a tenth coolant line configured to allow the coolant to flow and including a first end connected to the control valve, wherein the condenser is connected to the tenth coolant line; and
an eleventh coolant line including a first end connected to a second end of the first coolant line and a second end of the seventh coolant line, and including a second end connected to a second end of the ninth coolant line and a second end of the tenth coolant line.

5. The heat pump system of claim 4, wherein:
the second end of the first coolant line is connected to the second end of the seventh coolant line; and
a second end of the second coolant line is connected to the fourth coolant line between the chiller and a second end of the fourth coolant line.

6. The heat pump system of claim 4, wherein:
a second end of the fourth coolant line and a second end of the eighth coolant line are connected to a second end of the sixth coolant line; and
the second end of the seventh coolant line is connected to the second end of the first coolant line.

7. The heat pump system of claim 4, wherein the coolant heater comprises:
a first heater connected to the sixth coolant line;
a second heater connected to the ninth coolant line; and
a controller configured to control operations of the first heater and the second heater.

8. The heat pump system of claim 4, wherein the control valve is configured to control the flowing movement of the coolant according to at least one mode for adjusting a temperature of a vehicle interior or for adjusting a temperature of the battery,
wherein the at least one mode comprises:
a first mode for cooling the electrical component and the battery by using the coolant cooled in the radiator while cooling the vehicle interior;
a second mode for cooling the electrical component by using the coolant cooled in the radiator, and for cooling the battery by using the coolant heat-exchanged with the refrigerant, while cooling the vehicle interior;
a third mode for cooling the electrical component and the battery by using the coolant cooled in the radiator while heating the vehicle interior;
a fourth mode for cooling the electrical component by using the coolant cooled in the radiator, and for cooling the battery by using the coolant heat-exchanged with the refrigerant, while heating the vehicle interior;
a fifth mode for heating the battery by using the waste heat of the electrical component, while heating the vehicle interior;
a sixth mode for recollecting the waste heat of the electrical component, and heating the battery while heating the vehicle interior; and
a seventh mode for recollecting an ambient air heat and the waste heat of the electrical component, and heating the battery while heating the vehicle interior.

9. The heat pump system of claim 8, wherein, in the first mode:
the first coolant line, the third coolant line, the fourth coolant line, the fifth coolant line, the sixth coolant line, the seventh coolant line, and the tenth coolant line are configured to be opened by the control valve;
the second coolant line, the eighth coolant line, and the ninth coolant line are configured to be closed by the control valve;
the eleventh coolant line is configured to be opened;
the third coolant line is connected to the first coolant line by the control valve;
the fourth coolant line is connected to the fifth coolant line by the control valve;
the seventh coolant line is connected to the sixth coolant line and the tenth coolant line by the control valve;
the refrigerant line connecting the compressor, the condenser, the first expansion valve, and the evaporator in the air conditioner unit is configured to be opened by the first expansion valve;
the refrigerant connection line is configured to be closed by the second expansion valve; and
the first expansion valve is configured to expand the refrigerant introduced through the refrigerant line and supply the refrigerant expanded by the first expansion valve to the evaporator.

10. The heat pump system of claim 8, wherein, in the second mode:
the first coolant line, the third coolant line, the fourth coolant line, the fifth coolant line, the sixth coolant line, the seventh coolant line, and the tenth coolant line are configured to be opened by the control valve;
the second coolant line, the eighth coolant line, and the ninth coolant line are configured to be closed by the control valve;
the eleventh coolant line is configured to be opened;
the third coolant line is connected to the first coolant line by the control valve;
the fourth coolant line is connected to the sixth coolant line by the control valve;
the seventh coolant line is connected to the fifth coolant line and the tenth coolant line by the control valve;
the refrigerant line connecting the compressor, the condenser, the first expansion valve, and the evaporator in the air conditioner unit is configured to be opened by the first expansion valve;
the refrigerant connection line is configured to be opened by the second expansion valve;
the first expansion valve is configured to expand the refrigerant introduced through the refrigerant line and supply the refrigerant expanded by the first expansion valve to the evaporator; and
the second expansion valve is configured to expand the refrigerant introduced through the refrigerant connection line and supply the refrigerant expanded by the second expansion valve to the chiller.

11. The heat pump system of claim 8, wherein, in the third mode:
the first coolant line, the third coolant line, the fourth coolant line, the fifth coolant line, the sixth coolant line, the seventh coolant line, the ninth coolant line, and the tenth coolant line are configured to be opened by the control valve;
the second coolant line and the eighth coolant line are configured to be closed by the control valve;
the eleventh coolant line is configured to be closed;
the third coolant line is connected to the first coolant line by the control valve;
the fourth coolant line is connected to the fifth coolant line by the control valve;
the seventh coolant line is connected to the sixth coolant line by the control valve;
the ninth coolant line is connected to the tenth coolant line by the control valve;
a portion of the refrigerant line connecting the compressor, the condenser, and the refrigerant connection line in the air conditioner unit is configured to be opened;
a remaining portion of the refrigerant line connecting the refrigerant connection line, the first expansion valve, and the evaporator is configured to be closed by the first expansion valve;
the refrigerant connection line is configured to be opened by the second expansion valve;
an operation of the first expansion valve is configured to be stopped; and
the second expansion valve is configured to expand the refrigerant introduced through the refrigerant connection line and supply the refrigerant expanded by the second expansion valve to the chiller.

12. The heat pump system of claim 8, wherein, in the fourth mode:
the first coolant line, the third coolant line, the fourth coolant line, the fifth coolant line, the sixth coolant line, the seventh coolant line, the ninth coolant line, and the tenth coolant line are configured to be opened by the control valve;
the second coolant line and the eighth coolant line are configured to be closed by the control valve;
the eleventh coolant line is configured to be closed;
the third coolant line is connected to the first coolant line by the control valve;
the fourth coolant line is connected to the sixth coolant line by the control valve;
the seventh coolant line is connected to the fifth coolant line by the control valve;
the ninth coolant line is connected to the tenth coolant line by the control valve;
a portion of the refrigerant line connecting the compressor, the condenser, and the refrigerant connection line in the air conditioner unit is configured to be opened;
a remaining portion of the refrigerant line connecting the refrigerant connection line, the first expansion valve, and the evaporator is configured to be closed by the first expansion valve;
the refrigerant connection line is configured to be opened by the second expansion valve;
an operation of the first expansion valve is configured to be stopped; and
the second expansion valve is configured to expand the refrigerant introduced through the refrigerant connection line and supply the refrigerant expanded by the second expansion valve to the chiller.

13. The heat pump system of claim 8, wherein, in the fifth mode:
the first coolant line, the second coolant line, the seventh coolant line, and the eighth coolant line are configured to be closed by the control valve;
the third coolant line, the fourth coolant line, the fifth coolant line, the sixth coolant line, the ninth coolant line, and the tenth coolant line are configured to be opened by the control valve;
the eleventh coolant line is configured to be closed;
the third coolant line is connected to the sixth coolant line by the control valve;
the fourth coolant line is connected to the fifth coolant line by the control valve;
the ninth coolant line is connected to the tenth coolant line by the control valve;
a portion of the refrigerant line connecting the compressor, the condenser, and the refrigerant connection line in the air conditioner unit is configured to be opened;
a remaining portion of the refrigerant line connecting the refrigerant connection line, the first expansion valve, and the evaporator is configured to be closed by the first expansion valve;
the refrigerant connection line is configured to be opened by the second expansion valve;
an operation of the first expansion valve is configured to be stopped; and
the second expansion valve is configured to expand the refrigerant introduced through the refrigerant connection line and supply the refrigerant expanded by the second expansion valve to the chiller.

14. The heat pump system of claim 8, wherein, in the sixth mode:
the first coolant line and the seventh coolant line are configured to be closed by the control valve;
the second coolant line, the third coolant line, the fourth coolant line, the fifth coolant line, the sixth coolant line, the eighth coolant line, the ninth coolant line, and the tenth coolant line are configured to be opened by the control valve;
the eleventh coolant line is configured to be closed;
the third coolant line is connected to the second coolant line by the control valve;
the fourth coolant line is connected to the fifth coolant line by the control valve;
the eighth coolant line is connected to the sixth coolant line by the control valve;
the ninth coolant line is connected to the tenth coolant line by the control valve;
a portion of the refrigerant line connecting the compressor, the condenser, and the refrigerant connection line in the air conditioner unit is configured to be opened;
a remaining portion of the refrigerant line connecting the refrigerant connection line, the first expansion valve, and the evaporator is configured to be closed by the first expansion valve;
the refrigerant connection line is configured to be opened by the second expansion valve;
an operation of the first expansion valve is configured to be stopped; and
the second expansion valve is configured to expand the refrigerant introduced through the refrigerant connection line and supply the refrigerant expanded by the second expansion valve to the chiller.

15. The heat pump system of claim 8, wherein, in the seventh mode:
the first coolant line, the second coolant line, the third coolant line, the fourth coolant line, and the fifth coolant line are configured to be opened by the control valve;
the sixth coolant line, the seventh coolant line, the eighth coolant line, the ninth coolant line, and the tenth coolant line are configured to be opened by the control valve;
the eleventh coolant line is configured to be closed;
the second coolant line is connected to the first coolant line by the control valve;
the third coolant line is connected to the fourth coolant line by the control valve;
the seventh coolant line is connected to the fifth coolant line by the control valve;
the eighth coolant line is connected to the sixth coolant line by the control valve;
the ninth coolant line is connected to the tenth coolant line by the control valve;
a portion of the refrigerant line connecting the compressor, the condenser, and the refrigerant connection line in the air conditioner unit is configured to be opened;
a remaining portion of the refrigerant line connecting the refrigerant connection line, the first expansion valve, and the evaporator is configured to be closed by the first expansion valve;
the refrigerant connection line is configured to be opened by the second expansion valve;
an operation of the first expansion valve is configured to be stopped; and
the second expansion valve is configured to expand the refrigerant introduced through the refrigerant connection line and supply the refrigerant expanded by the second expansion valve to the chiller.

16. The heat pump system of claim 4, wherein the control valve comprises:
a first port connected to the first end of the first coolant line;
a second port connected to the first end of the second coolant line;
a third port connected to the first end of the third coolant line; and
a fourth port connected to the first end of the fourth coolant line.

17. The heat pump system of claim 16, wherein the control valve comprises:
a fifth port connected to the first end of the fifth coolant line;
a sixth port connected to the first end of the sixth coolant line;
a seventh port connected to the first end of the seventh coolant line;
an eighth port connected to the first end of the eighth coolant line;
a ninth port connected to the first end of the ninth coolant line; and
a tenth port connected to the first end of the tenth coolant line.

18. The heat pump system of claim 4, further comprising at least one water pump configured to force the coolant to flow through at least one coolant line among the plurality of coolant lines,
wherein the at least one water pump comprises:
a first water pump connected to a fifth port;
a second water pump connected to a sixth port; and
a third water pump connected a tenth port.

19. The heat pump system of claim 4, wherein a reservoir tank is connected to the seventh coolant line.

20. The heat pump system of claim 2, wherein the air conditioner unit further comprises a HVAC module including the heater core and the evaporator, the HVAC module including an opening/closing door configured to adjust air having passed through the evaporator to be selectively introduced into the heater core based on cooling or heating of a vehicle interior.
